(19) United States
(12) Patent Application Publication
(10) Pub. No.: US 2026/0368614 A1
(43) Pub. Date: Nov. 19, 2026

(54) ARTIFICIAL INTELLIGENCE MODELING THAT CONSTRUCTS A FREE ENERGY SURFACE TO ENCODE A DATA DISTRIBUTION

(71) Applicant: UNIVERSITY OF HOUSTON SYSTEM, Houston, TX (US)

(72) Inventors: Vassiliy Lubchenko, Houston, TX (US); Yang He, Houston, TX (US)

(73) Assignee: UNIVERSITY OF HOUSTON SYSTEM, Houston, TX (US)

(21) Appl. No.: 19/133,441

(22) PCT Filed: Nov. 24, 2023
(86) PCT No.: PCT/US2023/081040

§ 371 Date: May 28, 2025

Related U.S. Application Data
(60) Provisional application No. 63/428,342, filed on Nov. 28, 2022.
(60) Provisional application No. 63/463,765, filed on May 3, 2023.

(51) Int. Cl. G06N 20/00

(52) U.S. Cl. CPC G06N 20/00

(57) ABSTRACT

A method, computer program product and system for improving the accuracy in artificial intelligence modeling in recognizing patterns and drawings conclusions in a manner that emulates human expertise. An arbitrary distribution of data is received. A free energy surface is constructed, in a memory, that encodes the arbitrary distribution of data, where correlations in the encoded data correspond to separate individual minima on the free energy surface. Information may then be retrieved from the free energy surface, such as via interrogation of the multiple energy functions used to encode the arbitrary distribution of data.

### CROSS REFERENCE TO RELATED APPLICATIONS

This application claims priority to U.S. Provisional Patent Application Ser. No. 63/428,342 entitled “Multi-Expert Artificial Intelligence Systems,” filed on Nov. 28, 2022, which is incorporated by reference herein in its entirety.

This application further claims priority to U.S. Provisional Patent Application Ser. No. 63/463,765 entitled “Artificial Intelligence Modeling that Constructs a Free Energy Surface to Encode a Data Distribution,” filed on May 3, 2023, which is incorporated by reference herein in its entirety.

### STATEMENT REGARDING FEDERALLY SPONSORED RESEARCH

This invention was made with government support under Grant Nos. 1465125, 1531814, and 1956389 awarded by the National Science Foundation. The government has certain rights in the invention.

### TECHNICAL FIELD

The present disclosure relates generally to artificial intelligence modeling, and more particularly to implementing artificial intelligence modeling that constructs a free energy surface capable of encoding a data distribution, where the correlations in the data correspond to separate individual minima on the free energy surface.

### BACKGROUND

Artificial intelligence (AI) modeling is the creation, training, and deployment of machine learning algorithms that emulate logical decision-making based on available data. AI models provide a foundation to support advanced intelligence methodologies, such as real-time analytics, predictive analytics, and augmented analytics.

These models use various types of algorithms, such as linear or logistic regression, to recognize patterns in the data and draw conclusions in a manner that emulates human expertise. Simply put, AI modeling is the creation of a decision-making process that follows three basic steps: modeling, AI model training and inference.

The modeling step refers to creating an AI model, which uses a complex algorithm or layers of algorithms that interpret data and make decisions based on that data. A successful AI model can act as a surrogate for human expertise in any given use case.

The AI model training step refers to training the AI model. Most often, training involves processing large amounts of data through the AI model in iterative test loops and checking the results to ensure accuracy, and that the model is behaving as expected and desired. Engineers are on hand during this process to modify and improve the AI model as it learns.

The inference step refers to the deployment of the AI model into its real-world use case, where the AI model routinely infers logical conclusions based on available data.

Unfortunately, current approaches to machine learning are excessively heuristic. Existing methods of training amount to optimization of the so called cost (or loss) function, which measures the deviation of the output of the computation from the desired value. The loss function, as a function of the internal parameters of the machine, represents an energy-like landscape. As training progresses, the system becomes progressively “cooler” thus increasing the probability of becoming trapped in a wrong minimum. Such standard training protocols produce a broad distribution of performance. Sometimes the training results in a set of weights and biases for an artificial neural network that performs very poorly, while it does not seem possible to controllably avoid such catastrophic failures.

Hence, AI modeling is currently deficient in terms of accurately recognizing patterns in the data and drawing conclusions in a manner that emulates human expertise.

### SUMMARY

In one embodiment of the present disclosure, a computer-implemented method for artificial intelligence modeling comprises receiving an arbitrary distribution of data. The method further comprises constructing, in a memory, a free energy surface that encodes the arbitrary distribution of data, wherein correlations in the encoded data correspond to separate individual minima on the free energy surface.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of the hardware configuration of a computing device which is representative of a hardware environment for practicing the present disclosure;

FIG. 2 is a flowchart of a method for artificial intelligence modeling in accordance with an embodiment of the present disclosure;

FIGS. 3A and 3B illustrate the free energy F(J) in accordance with an embodiment of the present disclosure;

FIG. 4 illustrates the time traces of energy, the variable J, and the spin σ in accordance with an embodiment of the present disclosure;

FIGS. 5A-5C illustrate normalized auto-correlation functions for the simplest memory unit from simulations conducted for a range of temperatures covering all possible types of dynamics in accordance with an embodiment of the present disclosure;

FIG. 6 is a schematic depiction of the Marcus parabolas in accordance with an embodiment of the present disclosure;

FIG. 7 illustrates the logarithm of relaxation time for configurational equilibration as a function of 1/T in accordance with an embodiment of the present disclosure;

FIGS. 8A-8C illustrate the normalized auto-correlation functions of the simplest memory unit simulated so that the spin is flipped unconditionally every 1000 MC (Monte Carlo) steps in accordance with an embodiment of the present disclosure;

FIGS. 9A-9C illustrate normalized auto-correlation functions of the simplest memory unit simulated using a parallel tampering method in accordance with an embodiment of the present disclosure;

FIGS. 10A-10C illustrate normalized auto-correlation functions of the simplest memory unit simulated using a number of relative frequencies of attempts to update σ and J in accordance with an embodiment of the present disclosure;

FIG. 11A illustrates a relaxation profile for vibrational relaxation on times shorter than the transfer time between distinct free energy minima in accordance with an embodiment of the present disclosure;

FIG. 11B illustrates a relaxation profile for long observation times when the distinct free energy minima have been visited in accordance with an embodiment of the present disclosure;

FIGS. 12A-12D illustrate the Helmholtz and Gibbs free energy of the single spin system after symmetry breaking in accordance with an embodiment of the present disclosure;

FIGS. 13A-13B illustrate symmetry breaking for the elemental memory unit which is signaled the appearance of two distance minima on the free energy surface in accordance with an embodiment of the present disclosure;

FIG. 14 illustrates the graphical illustration of the “tunneling” moves in accordance with an embodiment of the present disclosure;

FIGS. 15A-15C illustrate the normalized auto-correlation functions for the simplest memory unit in accordance with an embodiment of the present disclosure;

FIGS. 16A-16C illustrate the trained p(J) for three values of the temperature in accordance with an embodiment of the present disclosure;

FIGS. 17A-17C illustrate the corresponding free energy profiles F(J)=−T lnp(J) in accordance with an embodiment of the present disclosure.

FIGS. 18A-18C illustrate pᵣₜᵣ(s) as a function of retrieval temperature T′ in accordance with an embodiment of the present disclosure;

FIGS. 19A-19H illustrate the time traces of the retrieved probabilities p(s) for four specific values of T′ and two values of the duration of the sampling, starting from some equilibrium configuration, in accordance with an embodiment of the present disclosure;

FIGS. 20A-20D illustrate retrieval probabilities pᵣₜᵣ(s) averaged over 200 stretches of training runs in accordance with an embodiment of the present disclosure;

FIGS. 21A-21C illustrate normalized auto-correlation functions of the simplest memory unit, with tunneling, in accordance with an embodiment of the present disclosure;

FIGS. 22A-22C illustrate the probability distribution p(J) for a single memory unit, p(σ=+1)p(σ=−1)=0.9/0.1, obtained using the tunneling move in accordance with an embodiment of the present disclosure;

FIGS. 23A-23C illustrate the free energy F(J) for p(σ=+1)p(σ=−1)=0.9/0.1, with tunneling, in accordance with an embodiment of the present disclosure;

FIGS. 24A-24I illustrate pᵣₜᵣ(s) as a function of retrieval time and temperature, with tunneling, in accordance with an embodiment of the present disclosure;

FIGS. 25A-25I illustrate pᵣₜᵣ(s) as a function of retrieval time and temperature, with tunnelling, with longer retrieval times in accordance with an embodiment of the present disclosure;

FIGS. 26A-26I illustrate pᵣₜᵣ(s) as a function of retrieval duration and temperature, with tunneling, where the variable J is vibrationally relaxed before using it for retrieval in accordance with an embodiment of the present disclosure;

FIGS. 27A-27B illustrate p(J) along the space diagonal of a J-cube in accordance with an embodiment of the present invention;

FIGS. 28A-28B illustrate pᵣₜᵣ(s) as a function of the retrieval temperature T′ for the well-resolved case in accordance with an embodiment of the present disclosure;

FIGS. 29A-29B illustrate pᵣₜᵣ(s) as a function of the retrieval temperature T′ for the poorly-resolved case in accordance with an embodiment of the present disclosure;

FIGS. 30A-30B illustrate p(J₁₂₃) for the generative model in accordance with an embodiment of the present disclosure;

FIGS. 31A-31B illustrate p(s) for the generative model in accordance with an embodiment of the present disclosure;

FIGS. 32A-32C illustrate normalized auto-correlation functions from HCBN simulation with different k values in accordance with an embodiment of the present disclosure;

FIGS. 33A-33C illustrate the distribution of J from the simulation in accordance with an embodiment of the present disclosure;

FIGS. 34A-34B illustrate the retrieval probability and free energy of different samples in accordance with an embodiment of the present disclosure;

FIG. 35 illustrates the probability gap between correct and incorrect retrievals in accordance with an embodiment;

FIGS. 36A-36F illustrate the distribution of J from the simulation in accordance with an embodiment of the present disclosure;

FIGS. 37A-37G illustrate the distribution of J from the simulation in accordance with an embodiment of the present disclosure;

FIGS. 38A-38E illustrate the normalized auto-correlation functions from the HCBN simulation with different k values in accordance with an embodiment of the present disclosure;

FIGS. 39A-39B illustrate the free energy gap contour map with different k values in accordance with an embodiment of the present disclosure;

FIG. 40A illustrates visible spins in accordance with an embodiment of the present disclosure;

FIG. 40B illustrates a fourth, added hidden spin in accordance with an embodiment of the present disclosure;

FIGS. 41A-41B illustrate the three-body interaction fitting coefficients as a function of temperature in accordance with an embodiment of the present disclosure;

FIGS. 42A-42F illustrate the normalized auto-correlation functions of a network of 1 hidden spin in accordance with an embodiment of the present disclosure;

FIGS. 43A-43D illustrate pᵣₜᵣ(s) as a function of T′, following Eq. (85), in accordance with an embodiment of the present disclosure;

FIGS. 44A-44D illustrate pᵣₜᵣ(s) as a function of T′, following Eq. (86), in accordance with an embodiment of the present disclosure;

FIGS. 45A-45D illustrate the average output with the feed-forward method in accordance with an embodiment of the present disclosure;

FIGS. 46A-46F illustrate the normalized auto-correlation functions for the network with 4 hidden spins in accordance with an embodiment of the present disclosure;

FIGS. 47A-47D illustrate pᵣₜᵣ(s) as a function of T′ where the network has 4 hidden spins in accordance with an embodiment of the present disclosure;

FIGS. 48A-48D illustrate the modified pᵣₜᵣ(s) as a function of T′ where the network has 4 hidden spins in accordance with an embodiment of the present disclosure; and

FIGS. 49A-49D illustrate the average output with the feed-forward method in accordance with an embodiment of the present disclosure.

### DETAILED DESCRIPTION

As stated in the Background section, artificial intelligence (AI) modeling is the creation, training, and deployment of machine learning algorithms that emulate logical decision-making based on available data. AI models provide a foundation to support advanced intelligence methodologies, such as real-time analytics, predictive analytics, and augmented analytics.

These models use various types of algorithms, such as linear or logistic regression, to recognize patterns in the data and draw conclusions in a manner that emulates human expertise. Simply put, AI modeling is the creation of a decision-making process that follows three basic steps: modeling, AI model training and inference.

The modeling step refers to creating an AI model, which uses a complex algorithm or layers of algorithms that interpret data and make decisions based on that data. A successful AI model can act as a surrogate for human expertise in any given use case.

The AI model training step refers to training the AI model. Most often, training involves processing large amounts of data through the AI model in iterative test loops and checking the results to ensure accuracy, and that the model is behaving as expected and desired. Engineers are on hand during this process to modify and improve the AI model as it learns.

The inference step refers to the deployment of the AI model into its real-world use case, where the AI model routinely infers logical conclusions based on available data.

Unfortunately, current approaches to machine learning are excessively heuristic. Existing methods of training amount to optimization of the so called cost (or loss) function, which measures the deviation of the output of the computation from the desired value. The loss function, as a function of the internal parameters of the machine, represents an energy-like landscape. As training progresses, the system becomes progressively “cooler” thus increasing the probability of becoming trapped in a wrong minimum. Such standard training protocols produce a broad distribution of performance. Sometimes the training results in a set of weights and biases for an artificial neural network that performs very poorly, while it does not seem possible to controllably avoid such catastrophic failures.

Hence, AI modeling is currently deficient in terms of accurately recognizing patterns in the data and drawing conclusions in a manner that emulates human expertise.

The principles of the present disclosure improve the accuracy in AI models recognizing patterns in the data and drawing conclusions in a manner that emulates human expertise by constructing a free energy surface that encodes an arbitrary distribution of data. As discussed herein, a reliable AI platform should implement an equilibrium sampling of a free energy landscape, not an energy landscape, and doing so at finite temperatures. By construction, then, the machine is intended to recurrently sample the full phase space of its internal parameters and, thus, not become captured in any specific configuration. In addition, the kinetics of reconfiguration can be controlled as well.

As discussed herein, there exists an energy function whose equilibrium Boltzmann weights can fully represent an arbitrary set of data and, hence, describe an arbitrary pattern. At the same time, although this underlying energy function exists, in principle, finding it is a computationally-insurmountable task. Conversely, energy functions of realistic size can represent only some aspects of the pattern. In turn, this dictates that multiple energy functions are employed to recreate general data sets, consistent with the motivation behind the Helmholtz machine. As a result, in one embodiment, the principles of the present disclosure are directed to a machine that can learn an arbitrary distribution of binary data. Such a machine may be thought of as a collection of energy functions, each collection being able to partially reproduce patterns, if any, in the data. Retrieval, then, requires interrogating all of these energy functions and yields acceptable quality after enough inquiries have been made. Informally speaking, if a single inquiry corresponds to an expert opinion, one needs to have a quorum of experts for a machine to reproduce data well. It is emphasized though that generally, none of the experts may be good enough to reproduce the full set of patterns present in the data. Only in those cases, when the correct underlying function is computationally manageable and, at the same time, is available or uncovered, does a single-expert situation become possible. In such cases, the retrieval becomes very efficient.

Furthermore, as discussed herein, a trained machine may be thought of as a condensed medium, whose degrees of freedom contain imprints of the data. These imprints are explicitly seen as minima on the free energy landscape as a function of the environmental degrees of freedom. Interrogation, then, amounts to using the free energy surface as a mold for a test function of the user's choice. In the worst case scenario, the number of free energy minima is 2^{N}, where N is the number of bits representing the problem in question, such as the pixels for a set of images. This worst case scenario comes about when there is no pattern to the data or when there is a pattern but there is no way for the user to determine it.

In one embodiment, as discussed further below, patterns are encoded by using many-body interactions between binary degrees of freedom, which are represented using Ising-like spins σ=±1. The space of all possible couplings of this sort is exponentially large, 2^{N}. Given the computational complexities of searching such a huge space, a setup is considered, where only two-body interactions are used, but introduce additional spins that do not directly represent the data. By using such hidden spins, higher-order interactions can be emulated between the “visible” spins, that directly represent the data. This modified generative model also does reasonably well in reproducing the distribution of data.

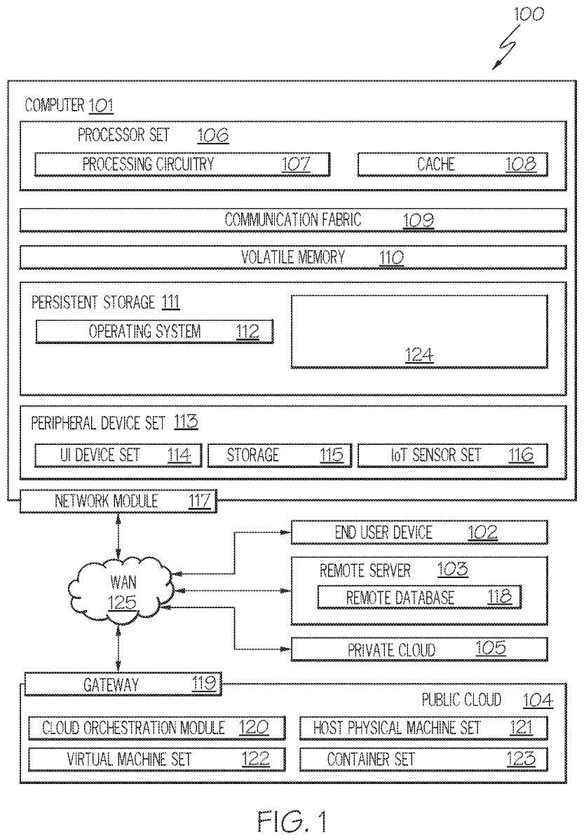

An embodiment of the present disclosure of the hardware configuration of a computing device which is representative of a hardware environment for practicing the present disclosure is discussed below in connection with FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 124) involved in performing the inventive methods, such as artificial intelligence modeling. In addition to block 124, computing environment 100 includes, for example, computer 101, network 125, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 124, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 124 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 124 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 125. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 125 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 125 to EUD 102. In this way, EUD 102 can display, or otherwise present, the recommendation to an end user. In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120. The computing resources provided by public cloud 104 are typically implemented by virtual computing environments that run on various computers making up the computers of host physical machine set 121, which is the universe of physical computers in and/or available to public cloud 104. The virtual computing environments (VCEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 119 is the collection of computer software, hardware, and firmware that allows public cloud 104 to communicate through WAN 125.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 125 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

Block 124 further includes the software components to perform the functions discussed herein regarding artificial intelligence modeling. In one embodiment, such components may be implemented in hardware. The functions discussed herein performed by such components are not generic computer functions. As a result, computer 101 is a particular machine that is the result of implementing specific, non-generic computer functions.

In one embodiment, the functionality of such software components of computer 101, including the functionality for artificial intelligence modeling, may be embodied in an application specific integrated circuit.

As stated above, AI modeling is currently deficient in terms of accurately recognizing patterns in the data and drawing conclusions in a manner that emulates human expertise.

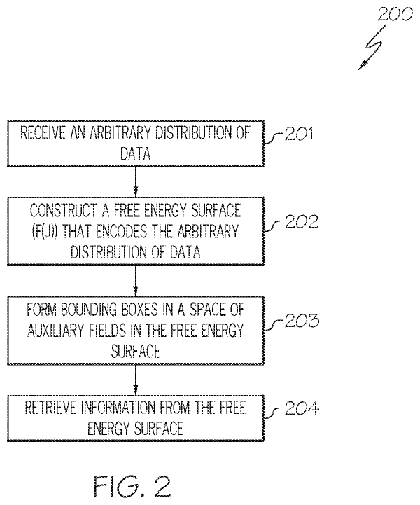

A discussion regarding a method for improving the accuracy in AI models recognizing patterns in the data and drawing conclusions in a manner that emulates human expertise by utilizing a free energy surface that encodes an arbitrary distribution of data is provided below in connection with FIG. 2.

FIG. 2 is a flowchart of a method 200 for artificial intelligence modeling in accordance with an embodiment of the present disclosure.

Referring to FIG. 2, in conjunction with FIG. 1, in step 201, an arbitrary distribution of data is received. A distribution of data, as used herein, refers to the possible values for a variable. Distributions are considered to by any population that has a scattering of data. An “arbitrary distribution of data,” as used herein, refers to the possible values for a variable being random.

In step 202, a free energy surface (F(J)) is constructed in memory that encodes the arbitrary distribution of data. The free energy surface, as used herein, refers to free energy at a finite temperature and includes entropic contributions stemming from the thermal fluctuations of the data spin σ. “Encoding,” as used herein, refers to a process of putting a sequence of characters (e.g., numbers) into a specialized format, such as for efficient transmission or storage.

In one embodiment, the correlations in the encoded data correspond to separate individual minima (minimum value) on the free energy surface.

In one embodiment, the separate individual minima include bounding boxes that store at least some information from the arbitrary distribution of data such that at least one dimension of each of the bounding boxes provides a probability of observing a given pattern.

In one embodiment, multiple energy functions are utilized to encode the arbitrary distribution of data. An energy function, as used herein, refers to a function of the configuration of latent variables and the configuration of inputs provided in an example.

In step 203, bounding boxes in a space of auxiliary fields are formed in the free energy surface. In one embodiment, such bounding boxes indicate values of binary variables whose statistics are to be recorded. A “bounding box,” as used herein, refers to a boundary in the space of auxiliary fields establishing the limits of values of the binary variables. Auxiliary fields, as used herein, refers to a non-physical field which is generally added to a QFT Lagrangian to impose some constraints: dynamical or otherwise. Furthermore, auxiliary field, as used herein, is one whose equations of motions admit a single solution. In one embodiment, the auxiliary fields indicate signs of the binary variables.

In one embodiment, quadratic confining potentials are used for the auxiliary fields. A confining potential, as used herein, refers to a smoothy varying set of site energies which concentrates the particle density, such as near a lattice center. A quadratic confining potential refers to a confining potential in terms of the second degree.

In step 204, information from the free energy surface is retrieved. For example, information from the free energy surface is retrieved via interrogation of a plurality of the multiple energy functions, such as the multiple energy functions used to encode the arbitrary distribution of data.

A more detailed description of method 200, including utilizing various examples for implementing method 200, is provided below.

In one embodiment, the principles of the present disclosure compose an energy function that has a computationally manageable number of low energy internal states that almost exclusively correspond to correct patterns. In one embodiment, these low energy states that encode correct patterns are well separated from those states that encode incorrect patterns. As discussed further below, the present disclosure utilizes a unique energy function whose Gibbs-Boltzmann distribution fully describes any conceivable distribution of data.

Because of the complexity of energy functions that encode general patterns in the data, it is conceded that the internal configurations of a machine that can be realistically created and trained will be able to encode only some of the correct patterns. This possibility is explicitly alluded to in the formulation of the Helmholtz machine, which expressly uses a number of putative energy functions (explanations).

Since a combinatorial multiplicity of energy states are used to encode information, in one embodiment, the internal states of the machine are weighed using the free energy, not energy, while working at a finite temperature. In one embedment, machines for performing AI modeling are operating at finite temperatures in order to overcome energetic barriers thus avoiding becoming trapped in energy or free energy minima corresponding to false patterns.

A discussion regarding equilibrium binary nets as generative models capable of reproducing arbitrary sets of digital data is discussed below.

In one embodiment, the present disclosure is directed to binary representations of data. Such binary representations of data are useful for deterministic computations, as performed by the conventional computers, since the strictly dichotomous character of binary variables allows for efficient error correction. And even when the signal seems to be intrinsically analog, the amount of information loss stemming from digitizing the signal can be controlled, as is reflected in the venerable Nyquist-Shannon sampling theorem.

In one embodiment, the principles of the present disclosure focus on generative models corresponding to equilibrated collections of pseudo-physical degrees of freedom. In such an embodiment, it is inquired as to whether it is possible to represent the data distributions using an equilibrium distribution corresponding to an explicit energy function. Furthermore, in one embodiment, the aforementioned energy function is a function of classical spin-1/2 variables, the latter spins representing the data. As discussed below, it is shown that there is a uniquely-defined, spin-based energy function whose Boltzmann distribution can describe an arbitrary distribution of data. That is, with respect to any statistical problem formulated in a digitized form, there corresponds a classical energy function in terms of Ising-like spins. It is first determined whether there is an explicit function E(σ₁, . . . , σ_{N}) such that

$${e}^{- β E ( {σ}_{1} , … , {σ}_{N} )} \frac{1}{Z ( β )} = p ( {σ}_{1} , … , {σ}_{N} ) \qquad ( 1 )$$

for every one of the 2^{N} combinations of the spin variables σᵢ=±1, i=1, . . . , N. The quantity

$$Z ≡ {\sum }_{\{ {σ}_{i} \}} {e}^{- β E ( {σ}_{1} , … , {σ}_{N} )} \qquad ( 2 )$$

is the usual partition function included to insure the probability distribution p (σ₁, . . . , σ_{N}) is normalized to one. The partition function Z does depend on temperature but not on the spin variables.

Because of σᵢ², the most general function of N such that variables are a sum of all possible products of the variables σ; each such product can contain any given spin variable at most once. Since the function itself is, by construction, an energy function, a product of n spin variables is routinely interpreted as an interaction that involves n spins while the numerical constant is interpreted as the respective coupling constant. Thus, one obtains the most general form for the energy function:

$$E ( {σ}_{1} , … , {σ}_{N} ) ≡ ( - {J}_{0} ) + {\sum }_{i} ( - {J}_{i} {σ}_{i} ) + {\sum }_{i < j} ( - {J}_{ij} {σ}_{i} {σ}_{j} ) + {\sum }_{i < j < k} ( - {J}_{ijk} {σ}_{i} {σ}_{j} {σ}_{k} ) + … \qquad ( 3 )$$

where an overall additive constant J, is included that can be used to choose the energy reference and, hence, the normalization constant for the Boltzmann distribution. The energy function above has exactly 2^{N} coupling constants, including the constant J₀, since there are N!/n! (N−n)! distinct erms of order n and the sum of the binomial coefficients

$$\begin{matrix}\text{?} N ! \vert / n ! ( N - n ) != {2}^{N}\end{matrix} .$$

$$\text{?} \text{indicates text missing or illegible when filed}$$

Equation (1) can be written as follows.

~E(σ₁, . . . ,σ_{N})=T ln[p(σ₁, . . . ,σ_{N})Z] (4)
which, in view of Eq. (3) is expressly a system of linear equations for the coupling constants. The r.h.s. (right hand side) of each equation is specified by the data. Hereby, in one embodiment, the number of samples that contains a specific combination of spins, such as σ₁=−1, σ₂=+1, . . . , σ_{N}=−1, etc. is counted followed by dividing that number by the total number of samples. Hence, the largest number of patterns that can be encoded as a set of binary samples, each of size N, is 2^{N}. Eq. (1), then, assigns an effective energy cost to each of these patterns. To avoid confusion, it is noted that the role of temperature in Eq. (1) is simply to set the units of energy.

All of the possible 2^{N} products of the spin variables σᵢ and unity form a complete set of the orthogonal basis in the Hamming space, where each function defined in the Hamming space can be written as a sum of these products. Thus, the system of equation (Eq, (4)) is well defined and has a unique solution

$${J}_{0} = \frac{1}{{2}^{N}} T {\sum }_{{σ}_{1} , … , {σ}_{N}} ln [ p ( {σ}_{1} , … , {σ}_{N} ) ] + T ln Z \qquad ( 5 )$$

$${J}_{i} = \frac{1}{{2}^{N}} T {\sum }_{{σ}_{1} , … , {σ}_{N}} {σ}_{i} ln [ p ( {σ}_{1} , … , {σ}_{N} ) ] \qquad ( 6 )$$

$${J}_{ij} = \frac{1}{{2}^{N}} T {\sum }_{{σ}_{1} , … , {σ}_{N}} {σ}_{i} {σ}_{j} ln [ p ( {σ}_{1} , … , {σ}_{N} ) ] \qquad ( 7 )$$

$${J}_{ijk} = \frac{1}{{2}^{N}} T {\sum }_{{σ}_{1} , … , {σ}_{N}} {σ}_{i} {σ}_{j} {σ}_{k} ln [ p ( {σ}_{1} , … , {σ}_{N} ) ] \qquad ( 8 )$$

$$… = …$$

Indeed, considering that realistic applications involve samples of size hundred or more, it is simply not feasible to collect adequate statistics for the function p({σᵢ}) since there are 2^{N} distinct combinations of the spin variables, as previously mentioned. Furthermore, it is essentially certain that the vast majority of the spin configurations will not be even present in the data. Consequently, the actual number of equations (Eq. (4)) is an astronomically tiny fraction of the greatest possible number 2^{N}. In turn, this means that only a tiny subset of all possible spin couplings will suffice to emulate the data.

That some interactions are missing can be thought of as the presence of a pattern. In other words, a set of rules that does not involve every possible combination of spins and, thus, is not a global set of rules, still allows one to define the system globally. Conversely, in the opposite extreme of the most general arrangement, in which the full set of coupling constants is specified, it might be said there is no pattern. Two illustrations of these notions is presented below.

Imagine an Ising chain that has only nearest-neighbor neighbor and the coupling is negative: J_{i,i+1}<0. The ground state of this system is any one of the two strictly alternating sequences of spin up and down, respectively—a simple pattern but a pattern nonetheless. As the temperature is raised, the pattern will become smeared, however, the correlations in all orders are still unambiguously determined by the same local rule, i.e., the interaction being nearest neighbor and repulsive.

Binary representations, specifically, allow one to look at patterns from a particularly vivid, symmetry viewpoint. Consider, for instance, a two-spin system, which, generally calls for three parameters, the two on-site fields, J₁ and J₂, and the two body coupling J₁₂. In the absence of the coupling, the energy function becomes:

E⁽¹⁾=−J₁σ₁−J₂O₂ (9)
while the space of the parameters is the (J₁, J₂) plane, a two-dimensional object. Consider a transformation that leaves the Hamiltonian above invariant:

Jᵢ,σᵢ→−Jᵢ,−σᵢ (10)

As a result of such transformations, the tip of the vector (J₁, J₂) will visit every one of the four corners of the rectangle (J₁, J₂), (−J₁, J₂), (J₁, −J₂), (−J₁, −J₂). This rectangle has two planes of symmetry, two rotational axes C₂, and an inversion center. The pattern encoded in Eq. (9) is that each spin has a preferred direction, irrespective of the other spin.

Now “turn on” the two-body coupling J₁₂. The space of the couplings is now three-dimensional:

E^{(1,2)}=−J₁σ₁−J₂σ₂−J₁₂σ₁σ₂ (11)

The tip of the three-dimensional vector (J₁, J₂) will now visit every one of the four corners of the tetrahedron (J₁, J₂, J₁₂), (−J₁, J₂, −J₁₂), (J₁, −J₂, −J₁₂), (−J₁, −J₂, J₁₂). The latter shape still has the two rotational axes C₂, in the (J₁, J₂) plane, but not the mirror planes or inversion center. Thus, adding the interaction lowers the symmetry of the problem. At the same time, not only can those symmetries be restored by setting J₁=J₂=0, but under the latter circumstances since the system is now fully rotationally symmetric in the (J₁, J₂) plane. But the J₁=J₂=0 case also corresponds to a pattern, namely, that the two spins prefer to point in the same direction, if J₁₂>0, and the opposite directions, if J₁₂<0. Other examples can be readily produced.

Now, it has been shown that the more general probability distributions require a greater number of coupling constants. At the same time, adding more coupling constants results in lowering of the symmetry of the shape produced by the symmetry transformation (Eq. (10)), as previously discussed. Thus, the presence of more patterns in the data may generally be associated with higher-symmetry shapes and, conversely, fewer patterns with lower-symmetry shapes. This observation is consistent with one's informal sense of what constitutes a pattern.

Now, since only a tiny subset of all possible spin couplings suffices to emulate the data in practical contexts, the general problem (Eq. (4)) becomes, somewhat paradoxically, hugely over-defined. Indeed, a subset of the coupling constants is chosen whose size matches the number of available values for the distribution function p({σᵢ}) of the data, yet it is not a priori obvious which subset it should be and, in the first place, what the size of the subset is. The data may be consistent with a number of patterns, all of which do comparably well in reproducing the data. In one embodiment, this list of plausible patterns is pruned by requiring that the reduced set of interactions result in a pertinent analog of the A_{N} matrix that has comparably large eigenvalues. Each of these analogs is actually a minor of the general A_{N} matrix. The logic behind this selection criterion is that the output of the calculation, in the form of coupling constants, should not be overly sensitive to the noise in the data.

But the real challenge is that owing to computational limitations, only relatively modest sets of couplings can be considered. Under these circumstances, the problem of finding an explicit energy function underlying the distribution of data becomes under-defined. In contrast with the seemingly paradoxical situation of being over-defined, discussed above, none of the computationally-feasible energy functions can actually explain the full set of patterns, but only a subset of patterns. Thus, more than one energy function is needed to explain the full set of patterns encoded in the data unless a perfect energy function is known a priori. As discussed below, explicit examples of such situations are constructed. At the same time, it is observed that the resulting sets of multiple distinct energy functions are non-unique and should generally be thought of as collections of Helmholtz machines, not a single Helmholtz machine.

The following is a discussion regarding a simplest memory unit and the emergence of activation.

It is proposed that a machine-learning platform be based on an energy function explicitly formulated in terms of putative dynamical variables, similar to the Hopfield network and the Boltzmann machine. The variables are classical and so there is no need to specify their inertial properties. The machine is composed of a number of elemental units, in each of which a non-linear degree of freedom is linearly coupled to a continuous degree of freedom. The continuous degree of freedom thus plays the role of the field that controls the distribution of the non-linear degree of freedom. The distribution of the value of this effective field, by construction, is determined during training.

In one embodiment, the simplest functional form for such an explicit energy function is obtained by stipulating that the nonlinear degree of freedom, by construction, has just two states and is represented by the Ising spin σ=±1:

$$E ( σ , J ) = - J σ + \frac{{kJ}^{2}}{2} . \qquad ( 12 )$$

The quantity J can thus be thought of as a field acting on the spin, analogous to the rank-one coupling J (1) in a Hopfield network (HN) or a Boltzmann machine (BM). By construction, J can be varied continuously. In contrast with vanilla formulations of HN and BM, a bounding potential is used to constrain the value of this variable to avoid its growing indefinitely during training. For mathematical simplicity, the quadratic potential kJ²/2 (k>0) is used, although other functional forms can be conceivably used. The model represented by Eq. (12) corresponds to one individual node of what is referred to herein as the “harmonically-constrained binary net” (HCBN).

In one embodiment, the model in Eq. (12) is used to encode the state of a single binary unit and incorporates the basic aspects of the present, free-energy based description, as discussed in the following.

Suppose that data is in the form of a long sequence of a binary variable σ=±1, where the probabilities p(σ=+1) and p(σ=−1) to be in state up and down are known. It is noted that p(σ=+1)+p(σ=−1)=1. It will be convenient to present the ratio of these probabilities as a ratio of two Boltzmann-like factors, according to:

$$\frac{p ( σ = + 1 )}{p ( σ = - 1 )} = \frac{{e}^{+ β h}}{{e}^{- β h}} = {e}^{2 β h} \qquad ( 13 )$$

so that the probability to have a value o can be thought of a given by the Boltzmann distribution for a spin σ subjected to a (pseudo) magnetic field h:

p(σ)∝e^{βhσ} (14)

or, equivalently,

$$h ≡ ( T / 2 ) ln \frac{p ( σ = + 1 )}{p ( σ = - 1 )} \qquad ( 15 )$$

As discussed above, an arbitrary distribution of binary data can be emulated using an energy function. Eq. (13) is an explicit example of doing so. To avoid confusion with the field J, the symbol h is used to describe the distribution of data.

Consider the following distribution function for the variable J as obtained by summing the Boltzmann weights corresponding to the energy function (Eq. (12)) over the state of the spin variable σ subject to the distribution in Eq. (14), aside from the inessential normalization function:

$$\begin{matrix}{p}_{tr} ( J ) & ∝ & {\sum }_{σ = \pm 1} \text{?} p ( σ ) ( 16 ) \\ & = & {\sum }_{σ = \pm 1} \text{?} ( 17 ) \\ & ∝ & {\sum }_{σ = \pm 1} \text{?} ( 18 ) \\ \\ & = & \text{?} ( 19 )\end{matrix}$$

$$\text{?} \text{indicates text missing or illegible when filed}$$

The summation over the “data” spin σ, subject to the distribution p(σ), represents a training of the generative model (Eq. (12)), hence the label “tr.” In the following, this label is dropped to avoid typographical clutter:

pₜᵣ(J)→p(J). (20)

This should not lead to confusion so long as only J is specified as the argument.

The distribution function p(J) in Eq. (16) is clearly a weighted sum of two Gaussian peaks. One peak corresponds to the data value σ=+1; it is centered at +k⁻¹ and is weighted by the Boltzmann weight e^{+βh}. The peak corresponding to the data value σ=−1 is centered at (−k⁻¹) and is weighted by the Boltzmann weight e^{-βh}. The width of each peak is ≃1/\sqrt{βk} and becomes sufficiently smaller than the separation between the peaks, 1/\sqrt{βk}<<2/k, so as to make the p(J) distribution strictly bimodal, when

k<<β (21)

In the strict limit k→0, the two peaks become strictly separated. Thus, if another spin-like degree of freedom s=±1 is subjected to a field J distributed according to the distribution p(J) in the k→0 limit, the state s=+1 with probability e^{+βh} and the state s=−1 with probability e^{-βh} are recovered, which is precisely the probability distribution of the data σ.

This notion suggests, then, how the p(J) distribution could be used to store and retrieve the distribution of the data. Different ways to retrieve can be conceived. For example, p(J) multiplied by the quantity e^{βJs} is integrated. The idea is that retrieval is a reverse process to training and so the expression e^{βJs} represents the Boltzmann weights for a spin s subjected to external field J. Integration over p(J) is, then, intended to impose on the test spin s the probability distribution of the field that was obtained by training over the distribution of the data. Thus, the following probability distribution for the test spin s is considered:

pᵣₜᵣ(s)≡C∫dJ p(J)e^{βJs}. (22)
where C is a constant independent of s. The retrieval protocol incarnated in the formula above has advantages and disadvantages to be discussed below alongside alternative detailed embodiments for retrieval protocols.

Eq. (22) yields straightforwardly

$$\frac{{p}_{rtr} ( s = + 1 )}{{p}_{rtr} ( s = - 1 )} = \frac{cosh β ( {k}^{- 1} + h )}{cosh β ( {k}^{- 1} - h )} \qquad ( 23 )$$

It is instructive to consider the limiting cases of this result. The most important limit is that of small k, which corresponds to the p(J) distribution having two separate, well-resolved peaks. Such a case will now be focused.

In the limit k→0, the probability distribution for the retrieval degree of freedom approaches the probability distribution of the data, Eq. (13):

$$\frac{{p}_{rtr} ( s = + 1 )}{{p}_{rtr} ( s = - 1 )} {\to }_{k \to 0} {e}^{2 β h} ( 1 - 2 {e}^{- \frac{2 β}{k}} sinh 2 β h ) \qquad ( 24 )$$

Furthermore, the leading asymptote yields the original probability distribution of the data, c.f. Eq. (13), irrespective of the machine parameters, namely the spring constant k. It is further observed that the deviation from the desired distribution in Eq. (13) scales in an activated fashion with the temperature, where the corresponding activation energy has a contribution 2/k as well as a contribution due to the field h, see also below.

To appreciate the appearance of activation in the problem, the distribution function p(J) from the energetic perspective is now discussed. An energy-like quantity F(J) is defined according to

$$\begin{matrix}F ( J ) & = & - T ln p ( J ) & ( 25 ) \\ & = & \frac{{kJ}^{2}}{2} - T ln ln [ 2 cosh β ( J + h ) ] & ( 26 )\end{matrix}$$

At a finite temperature, F(J) is a free energy and includes entropic contributions stemming from the thermal fluctuations of the data spin σ, consistent with the last term on the r.h.s. depending on temperature, which resulted from the thermal averaging over the configurations of the spin.

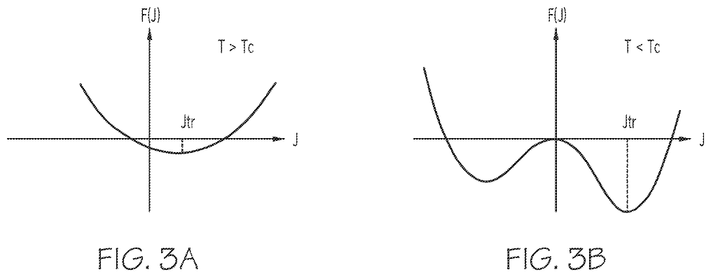

Clearly, for sufficiently small values of k, c.f. Eq. (21), the function above represents a double-well potential as illustrated in FIG. 3B. FIGS. 3A and 3B illustrate the free energy F(J) in accordance with an embodiment of the present disclosure. FIG. 3A exemplifies the situation corresponding to a single peak in the distribution p(J) while FIG. 3B illustrates a situation when the two peaks are well resolved. The r.h.s. and l.h.s. minima correspond to the field J pointing up and down, respectively. The two orientations encode the spin states up and down, respectively.

The p(J) distribution for the elemental unit is surveyable, but this lucidity will quickly disappear when the number of such units becomes large, thus calling for an automated way to train the memory units. To this end, it is noted that both the generative model and the distribution of data are explicitly represented as Boltzmann weights of an explicit energy function. Thus, the standard Monte Carlo sampling may be employed to generate the p(J) distribution. It is noted that the data spin σ is present in Eqs. (18-22) as a dummy variable. It can be explicitly monitored during training, if desired. Specifically, it is desired to equilibrate the system whose energy given by the expression

$${E}_{tr} ( σ , J ) = - J σ + \frac{{kJ}^{2}}{2} - h σ \qquad ( 27 )$$

per Eq. (17). To avoid confusion, the “training” field h is a pseudo-field used to emulate the probability distribution of the data, per Eq. (15), and is an external parameter that will depend on the specific data distribution. The “spring constant” k, on the other hand, is an intrinsic property of the machine irrespective of the data the machine may be asked to process.

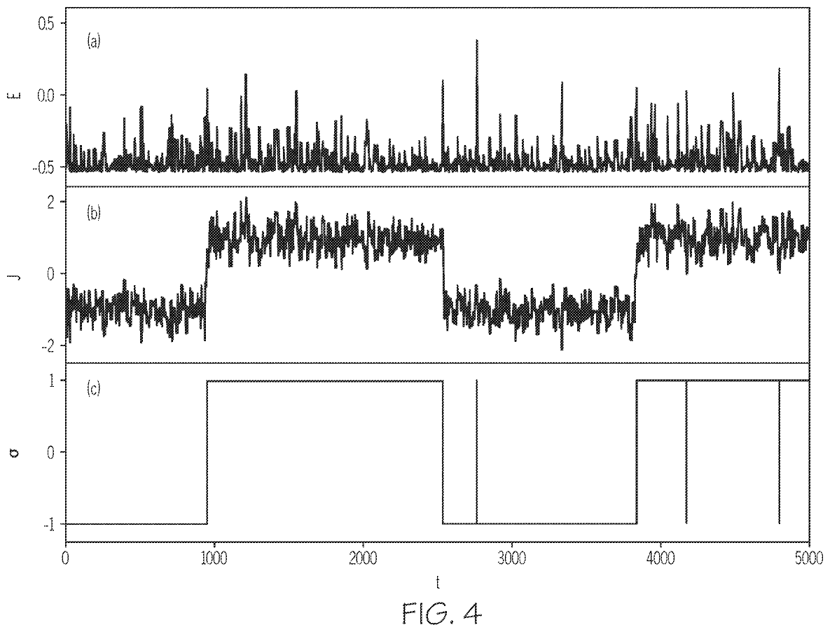

Next, it is demonstrated how to train the elemental unit using a simulation, where for clarity h=0. The latter arrangement is statistically equivalent to an equal measure of spins up and down, respectively, in the data. The results of the simulation are illustrated by first showing time traces of the energy and the variables J and σ in FIG. 4, stacked on top of each other so as to highlight mutual correlations among these variables.

FIG. 4 illustrates the time traces of energy, the variable J, and the spin σ in accordance with an embodiment of the present disclosure. Time is measured by the Monte Carlo steps. Attempts to update J and σ are equally likely. T=0.134, h=0.

Of particular interest are two-point auto-correlation functions defined according to:

C_{EE}(t)≡<E(t)E(0)²−<E>² (28)

C_{JJ}(t)≡<J(t)J(0)>−<J>² (29)

C_{σσ}(t)≡<σ(t)σ(0)>−<σ>² (30)

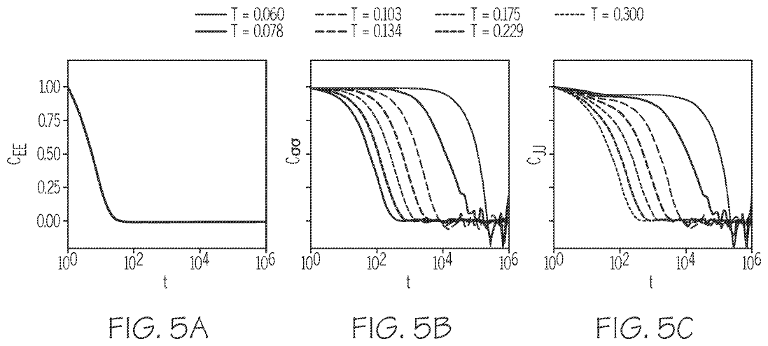

Examples of these two-point correlation functions are shown in FIGS. 5A-5C. FIGS. 5A-5C illustrate normalized auto-correlation functions for the simplest memory unit from simulations conducted for a range of temperatures covering all possible types of dynamics (see Eqs. (28-30)) in accordance with an embodiment of the present disclosure. The presence of activation is signaled by the appearance of a distinct shoulder at long times, k=1, h=0. The ratio of the attempts to update σ and J is 1:1.

It is observed that the energy relaxes very fast, much faster than the other degrees of freedom and appears to have only one type of relaxation. In contrast, the spin and the field variable J both appear to have two processes, as is evidenced by the two shoulders in the relaxation profiles. The fast shoulder is somewhat harder to view in the spin-spin correlation function—though it is indeed present there, see below—but it is clearly seen in the J-J correlation function. Already this notion suggests that the fast process corresponds to the vibrational relaxation within an individual well of the F(J) profile, while the slow process is accompanied by a spin flip and, thus, corresponds to transitions between the two wells. The latter is called the inter-well type of dynamics “configurational,” by analogy with relaxation in glassy liquids and solids, whose dynamics consist of transitions between distinct free energy minima, on the one hand, and vibrations within an individual free energy minimum, on the other hand. Because each free energy minimum corresponds to a metastable (aperiodic) configuration, the transitions between such minima are often designated as configurational dynamics. Furthermore, the configurational shoulder is often called the plateau, a term used herein.

The notion that the activated dynamics are present can be demonstrated by a number of additional observations, both general and purely numerical.

The following discusses the distinction between the equilibrium free energy from Eq. (26) and the pair of the energy terms for the field J, each corresponding to the states of the spin up and down, respectively:

$$V ( J , σ = + 1 ) = - ( J + h ) + \frac{{kJ}^{2}}{2} \qquad ( 31 )$$

$$V ( J , σ = - 1 ) = + ( J + h ) + \frac{{kJ}^{2}}{2} \qquad ( 32 )$$

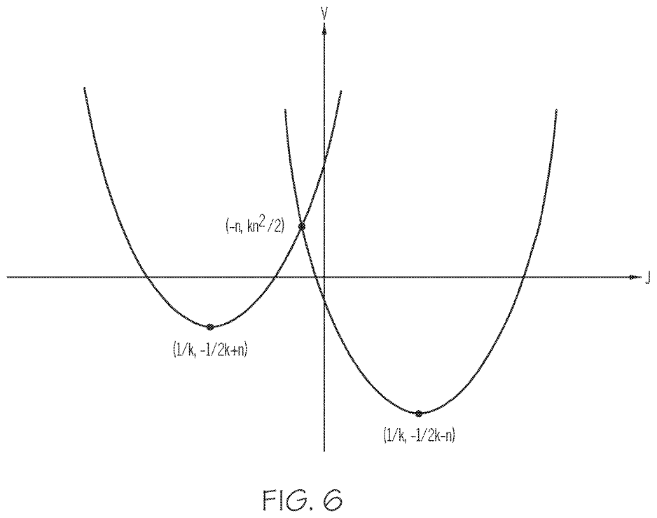

The two terms are parabolas whose minima are located at [1/k, (−1/2k)−h] and [−1/k, (−1/2k)+h], respectively, as shown in FIG. 6.

FIG. 6 is a schematic depiction of the Marcus parabolas from Eqs. (31 and 32) in accordance with an embodiment of the present disclosure. The two parabolas are completely analogous to the venerable Marcus parabolas of the theory of non-adiabatic transport in condensed media. When |h|<1/k, the minima of the individual terms are separated by a barrier in the form of a cusp located at [−h,kh²/2]. Otherwise, the barrier is outside the range [−1k, 1/k], resulting in what it is called the “Marcus-inverted” case. It is noted that in the Marcus-inverted region the more exothermic the process is, the slower it becomes. It is further noted that the reaction corresponds to the escape from the metastable minimum. This is the opposite of the trend that is usually exhibited by chemical reactions, the vast majority of which have transition states that more or less lie some place in the configuration space that interpolates between the reactant and product states, respectively. The reaction kinetics in the double-parabola setup from FIG. 6 is described straightforwardly by the following, standard reaction scheme:

\dot{p}₁=−k₁p₁+k₂p₂ (33)

\dot{p}₂=−k₂p₂+k₁p₁ (34)
where p₁ and p₂ arc the populations of states 1 and 2 corresponding, in the present case, to the two distinct states of the spin variable o. The rate constants k₁ and k₂ are the rates of escape from states 1 and 2, respectively. (Of course, p₁+p₂=1.) In equilibrium, \dot{p}ᵢ=0, the populations obey the detailed balance, i.e., the quantity (k₁p₁−k₂p₂) vanishes. Away from equilibrium, the latter quantity obeys the following equation:

$$\frac{d}{dt} ( {k}_{1} {p}_{1} - {k}_{2} {p}_{2} ) = - ( {k}_{1} + {k}_{2} ) ( {k}_{1} {p}_{1} - {k}_{2} {p}_{2} ) , \qquad ( 35 )$$

where the relaxation rate towards equilibrium is the sum of the escape rates from individual bound states.

For the setup in FIG. 6 and in the classical limit pertinent to the present analysis, this combined rate is equal to

$${k}_{rlxn} = {k}_{1} + {k}_{2} ∝ {e}^{- β ( {k}^{- 1} + {kh}^{2} ) / 2} 2 cosh β h \qquad ( 36 )$$

up to a proportionality constant determined by the detailed sampling protocol. In the h→0 limit, the relaxation rate is twice the escape rate from an individual minimum. This is an entropic effect stemming from the presence of two distinct configurations of the spin variable σ and is in correspondence with the lowering of the transition state of the free energy F(J) from Eq. (26), by the amount T ln2, relative to height of the cusp separating the minima of the individual parabolas in FIG. 6. It may be said that this is the entropic contribution to the free energy barrier for relaxation.

It is noted that in the absence of the externally induced bias, i.e., when h=0, the barrier separating the two minima is 1/2k. The activation energy 2/k in Eq. (24) is four times as much. Incidentally, this activation energy is analogous to the so called reorganization energy from the aforementioned theories for non-adiabatic particle transfer in condensed media, where this energy is also four times the activation barrier. In that theory, as well as in the present context, the reorganization energy corresponds to the cost of moving the particle if the vibrational ground state of the surrounding remains in place. From the statistical viewpoint, the reorganization energy simply reflects how much the tails of one peak in the probability distribution p(J) reaches over to the other peak and vice-versa, i.e., the probability to get the two peaks of the distribution “confused.”

In the Marcus-inverted region, there is the additional complication that exactly at the location of the metastable minimum, the wing of the larger peak of p(J) reaching over to the smaller peak is actually greater than the value of the smaller peak. Consequently, the two peaks in the p(J) distribution are not distinct, not because of a lack of separation between the peaks but because one of the peaks is too small. This does not necessarily mean that the contribution of the smaller peak is not there or that the corresponding information about the statistics of the less likely spin state is lost. Still, this situation does lead to complications as discussed below.

It has been shown that the introduction of the auxiliary field J allows one to separate distinct configurations represented in the data using a continuous variable. This occurs completely analogously to how the position of a charged particle in a continuum is determined by the electric and/or phonon field; the latter fields in fact enable the charged particle to engage in any interaction in the first place. Now, those distinct configurations of the data correspond to distinct peaks in the probability distribution p(J). The heights of the individual peaks, then, determine the probability of the corresponding configurations in the data. Conversely, when the peaks are overlapping, only the total probability of the corresponding configurational is available, but not the individual probabilities. Indeed, there are an infinite number of ways to decompose a number into a sum of numbers. This observation can be made vivid using the energetic representation of the probability distribution of p(J), i.e., via the free energy surface F(J). The maxima in the function p(J) correspond to distinct minima in the free energy curve F(J). When distinct, such minima can be thought of, quite literally, as separate boxes where information on the data-imposed field h is stored. The depth of each box reflects on how often the data from the box will be retrieved, typically. Indeed, in the T->0 limit (see FIG. 6), the difference in depth between the two wells is exactly 2h, c.f. Eqs. (13) and (24). Conversely, it is impossible to place two boxes in the same place in space. The latter situation would correspond to distinct peaks fully overlapping. Thus, it is concluded that to a formed piece of knowledge, a pattern if you will, there corresponds a free energy with multiple minima. Building this surface requires activation. Retrieval of knowledge can be thought of as the exploration of the free energy surface and also needs activation, which will be elaborated further below.

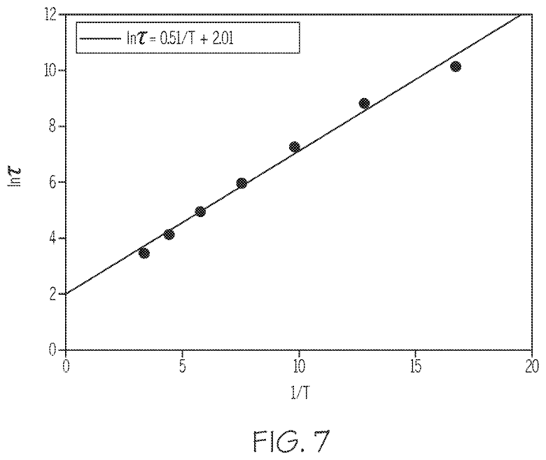

In view of the activation-like dependence in Eq. (24), already using the force constant k that is smaller than the inverse temperature, β, and, desirably, less than the inverse field, 1/|h|, will produce a retrieval distribution that is close numerically to the distribution of the data, notwithstanding the just discussed issues in the Marcus-inverted region. The value of k, then, is chosen as a compromise between the quality of the retrieved data and the time of retrieval. Thus, the above general discussion of activation can be directly tested by plotting the logarithm of the relaxation time for the slower of the two shoulders from FIGS. 5A-5C as a function of the inverse temperature as shown in FIG. 7.

FIG. 7 illustrates the logarithm of relaxation time for configurational equilibration as a function of 1/T in accordance with an embodiment of the present disclosure. The relaxation time is inferred from the position of the long-time shoulder in the C_{σσ} relaxation profile from FIGS. 5A-5C.

It is observed that the slope of the best linear fit, determined to be 0.51, is consistent with the aforementioned zero-temperature value of the barrier 1/2k=0.5. It is noted that some divergence between the two values is expected since the simulation is performed at a finite temperature implying a temperature-dependent entropic contribution to the activation rate.

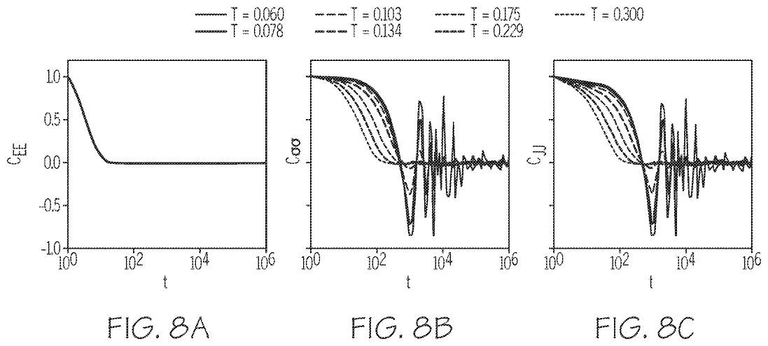

Another control experiment, so to speak, regarding the presence of activation can be performed by an ad hoc modification of the acceptance rules for spin moves. Instead of using the Metropolis criterion for accepting spin moves, the latter moves are accepted unconditionally. It is observed in FIGS. 8A-8C that this severely curtails both the configurational relaxation while the vibrational relaxation is still present.

FIGS. 8A-8C illustrate the normalized auto-correlation functions of the simplest memory unit simulated so that the spin is flipped unconditionally every 1000 MC (Monte Carlo) steps in accordance with an embodiment of the present disclosure. In connection with FIGS. 8A-8C, J is updated using the conventional Metropolis criterion and k=1.

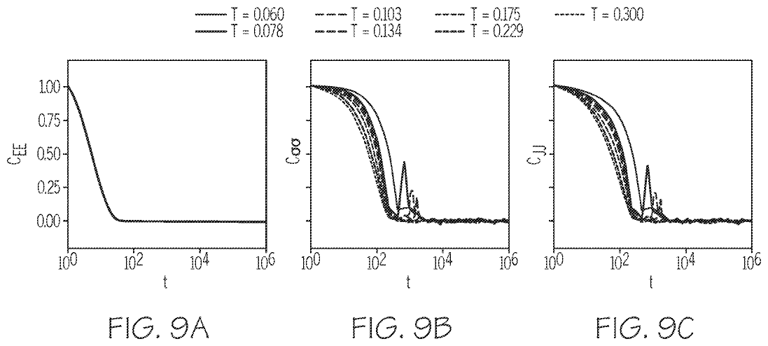

A similar effect can be achieved by using a replica-exchange Monte Carlo simulation. The high-T range samples exhibit much speedier transitions between the two minima of F(J) thus facilitating the transitions in the low-T set of samples. This results in a much faster configurational relaxation, as one can directly see in FIGS. 9A-9C.

FIGS. 9A-9C illustrate normalized auto-correlation functions of the simplest memory unit simulated using a parallel tampering method in accordance with an embodiment of the present disclosure. In connection with FIGS. 9A-9C, T=0.1, k=1. Furthermore, attempts to swap temperatures are undertaken every 200 MC steps.

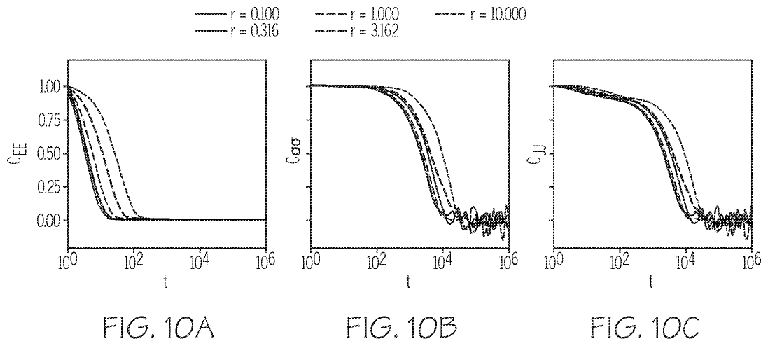

It is noted that the present setup includes an Ising spin-like degree of freedom which does not even allow for inertia; to change that one would have to switch to a soft-spin description, which would make simulation more expensive yet bring little additional insight, if at all. As a proxy for effects of inertia, several values of the relative frequency at which the spin moves and the J moves are attempted in the Monte Carlo simulation are employed. The results are exemplified in FIGS. 10A-10C.

FIGS. 10A-10C illustrate normalized auto-correlation functions of the simplest memory unit simulated using a number of relative frequencies of attempts to update o and J in accordance with an embodiment of the present disclosure. In connection with FIGS. 10A-10C, the simulation temperature is 0.1.

It is observed that while the relaxation times for both processes are sensitive to the precise value of the update rate for o and J, both processes are robustly present.

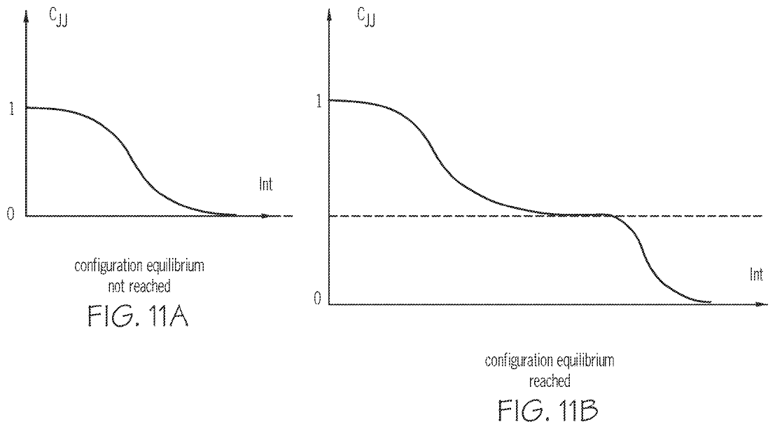

The following discusses how activated dynamics arise when the free energy surface has multiple minima, such as in the two-well situation corresponding to the single-spin memory unit. Suppose the r.h.s. and l.h.s. wells are centered at +J₀ and −J₀, respectively. Next, suppose the system was initiated in the r.h.s. well and has not yet had a chance to transition into the other well as if the other well did not even exist. Now, because the system does not “know” of the other well, it “thinks” that the average value of J is J₀, Thus, the <J(t)J(0)> correlation function relaxes toward J₀² on long times, the corresponding time scale reflecting the rate of vibrational relaxation. Once configurational dynamics sets in, however, the average value of J shifts to J₀+ (−J₀)=0. Thus, the baseline for the relaxation shifts from J₀² to 0. The corresponding time scale is now determined by the rate of configurational relaxation. The vibrational baseline now stays as a relic, i.e., in the form of a long-time shoulder, which is graphically explained in FIGS. 11A and 11B. Such a shoulder is referred to herein as the “plateau.”

Referring to FIG. 11A, FIG. 11A illustrates a relaxation profile for vibrational relaxation on times shorter than the transfer time between distinct free energy minima in accordance with an embodiment of the present disclosure. FIG. 11B illustrates a relaxation profile for long observation times when the distinct free energy minima have been visited in accordance with an embodiment of the present disclosure.

It is established that the amount of the decay of the J-J correlation before the plateau is reached is quantitatively related to the typical vibrational displacement, within an individual well, relative to the displacement during inter-well transitions. The height of the plateau itself has the meaning of the venerable Debye-Waller factor:

$$DWF = \frac{{J}_{0}}{{J}_{0} + δ {J}_{vibr}} \qquad ( 37 )$$

According to FIGS. 5A-5C, the vibrational amplitude within an individual well is about 5% of (one-half) of the inter-well spacing. This is less than, for instance, the value of the vibrational displacement in a stable solid, per the venerable Lindemann criterion of melting, consistent with the two peaks in the function p(J) being well separated.

Using the same reasoning as in the preceding paragraph, it is straightforward to understand why the vibrational portion of relaxation is hard to see in the spin-spin correlation functions. This is because the vibrational relaxation of a spin is proportional to the square root of it susceptibility. The susceptibility itself of a spin subject to field h is equal to 1/cosh²βh, resulting in δσ_{vibr} ≃1/cosh βh≈e^{-βJ}₀/2, a small number indeed for the conditions of the simulation.

The training of the memory unit can be thought of as equilibration of a system with energy. In contrast, retrieval, as embodied in Eq. (22), should be thought of as the test spin s subject to a fluctuating field; the statistics of the latter fluctuations are determined by the free energy F(J). And so, for instance, for the two-well situation in FIG. 3B, the spin will spend more time in the r.h.s. well, thus resulting in a probability distribution for the orientation of test spin s that closely approximates the distribution of the data spin σ. This will be discussed formally shortly.

Thus, the robustness of the retrieving of the distribution of data may be viewed as the stability of the field J against thermal fluctuation. In order for the direction of the field to be “scrambled”—thus effectively flipping the distribution pᵣₜᵣ(s)—thermal fluctuations need to be intense enough to overcome the barrier separating the two minima of the function F(J).

To further illustrate as to why it may be important for the probability distribution p(J) to have two peaks, it is instructive to consider the opposite limit k→∞, in which the two peaks of the p(J) function strongly overlap and, thus, cannot be told apart. In energetic terms this corresponds to the free energy F(J) having only one minimum, as shown in FIG. 3A, and the two parabolic diabats sitting essentially on top of each other. In this limit, the following is obtained straightforwardly:

$$\frac{{p}_{rtr} ( s = + 1 )}{{p}_{rtr} ( s = - 1 )} {\to }_{k \to ∞} 1 + \frac{2 β}{k} tanh β h \qquad ( 38 )$$

As expected, in the leading order, the model has no selectivity as to which direction the spin is to be directed. For a large, yet finite values of k and finite values of temperature, this unique minimum does retrace the direction of the field. However, the resulting distribution for the test spin s is quantitatively different from that prescribed by the data, while for a set of interacting spins, the distribution is qualitatively different.

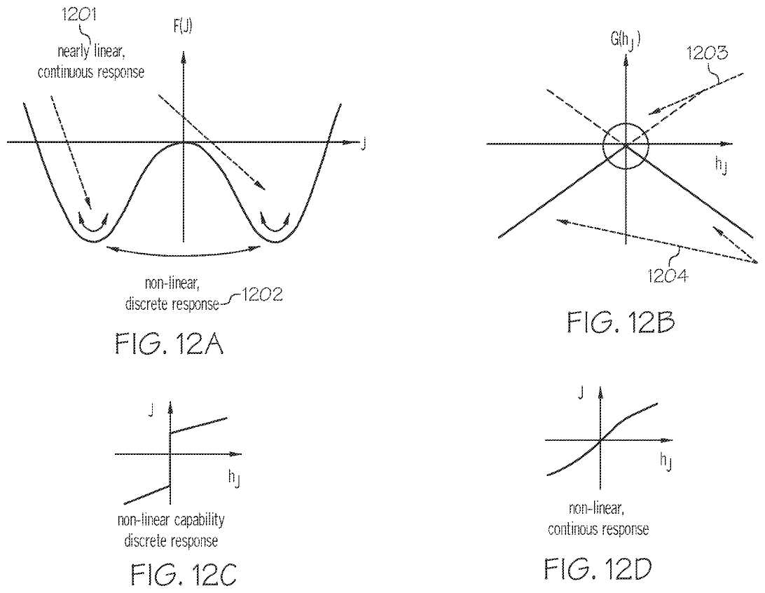

FIGS. 12A-12D illustrate the Helmholtz and Gibbs free energy of the single spin system after symmetry breaking in accordance with an embodiment of the present disclosure. FIG. 12A illustrates a nearly linear, continuous response 1201 as well as the non-linear, discrete response. Furthermore, FIG. 12C illustrates the non-linear capability discrete response shown in FIG. 12B (see 1203) and FIG. 12D illustrates the nearly linear, continuous response in FIG. 12B (see 1204).

In the one-minimum limit, each spin can be thought of as a weakly-nonlinear oscillator. The T→0 limit (while k>>|h|⁻¹) is particularly revealing. Hereby which the F(J) curves simply becomes a parabola p(J)→kJ²/2−|J+h|=k (J∓1/k)²/2+const that does not even depend on the data but simply reflects properties of the machine. This is not a robust arrangement. At finite temperatures, some dependence on the field h will be present, but even in that case, it is noted that a collection of coupled oscillators has a unique minimum with a rigidly prescribed spectrum. This may be thought of as individual spins not being able to preserve their polarization when coupled to other spins, which effectively occurs when data are correlated. Thus, it is conceivable yet seems unlikely that the one-minimum limit may be of any utility. It is reiterated that in the low-T limit when the machine is expected to be robust against noise, the properties of a trained machine do not depend on the data.

Conversely, the two-peak limit, k<<β, has the capacity to mimic arbitrary data (see also below). This is because a spin subject to a finite one-site field will hold its polarization robustly until a field, if any, due to interaction with other degrees of freedom exceeds a certain threshold value. Formally, this comes about because of the strongly non-linear dependence of the magnetization of a spin as a function of the field. This magnetization essentially saturates already at modest values of the field and changes little within a large range of the field. This robustness of the on-site field and its sigmoidal dependence on external is completely analogous to how a buffer maintains a steady pH within substantial ranges of the titrant. This notion, graphically illustrated in FIGS. 12A-12D, is best demonstrated by switching from the Helmholtz energy F(J) to the corresponding Gibbs energy, via the standard Legendre transformation:

$${{h}_{J} = \frac{\partial F}{\partial J} \vert}_{{J}_{eq}} \qquad ( 39 )$$

$$G ( {h}_{J} ) = F ( {J}_{eq} ( {h}_{J} ) ) - {hJ}_{eq} ( {h}_{J} ) \qquad ( 40 )$$

It is noted note that when the function F(J) has two minima, the Legendre transform is no longer single valued but becomes two-valued, the lower value corresponding to the stable minimum of F(J).

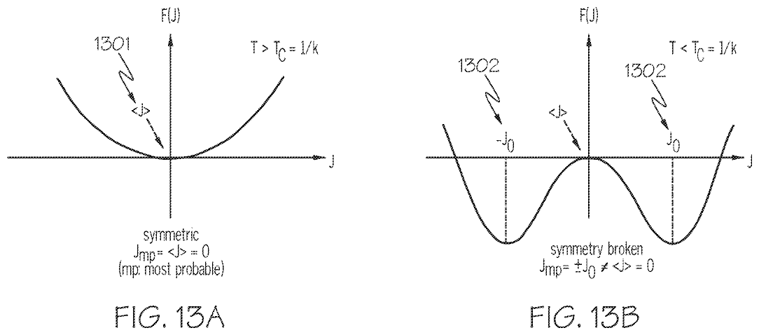

Finally, it is pointed out that the emergence of distinct free minima represents an instance of symmetry breaking and is an emergent phenomenon. The fact of symmetry breaking is most lucidly illustrated when the bias field h is set to zero as shown in FIGS. 13A-13B, which formally corresponds to the memory unit storing typically the same number of spins oriented up and down, respectively.

FIGS. 13A-13B illustrate this symmetry breaking for the elemental memory unit which is signaled the appearance of two distance minima on the free energy surface in accordance with an embodiment of the present disclosure. As shown in FIG. 13A, there is symmetry where Jₘₚ=<J>=0 (see 1301), where mp means most probable. As shown in FIG. 13B, symmetry is broken, as shown by Jₘₚ=±J₀≠<J>=0 (see 1302).

A discussion regarding an illustration of utilizing the principles of the preset disclosure in connection with a harmonically constrained binary net is provided below.

It will be useful to restate here the definition of the generative model from the preceding in a way that does not explicitly involve the pseudo-field from Eq. (16). And so,

$$p ( J ) ∝ {\sum }_{σ = \pm 1} {e}^{- β E ( σ , J )} p ( σ ) . \qquad ( 41 )$$

where the energy function is from Eq. (12), which is reproduced here for convenience:

$$E ( σ , J ) = - J σ + \frac{{kJ}^{2}}{2} \qquad ( 42 )$$

In contrast with the preceding discussion, the retrieval procedure is generalized so as to allow one to tune the temperature in the factor e^{βJS}:

pᵣₜᵣ(s)=∫dJ p(J)e^{β′Js}. (43)
where β′≡1/T′. Alternatively, using a different temperature, in the retrieval formula above, can be thought of as a way to enhance or diminish the field acting on the test spin, relative to the data spin.

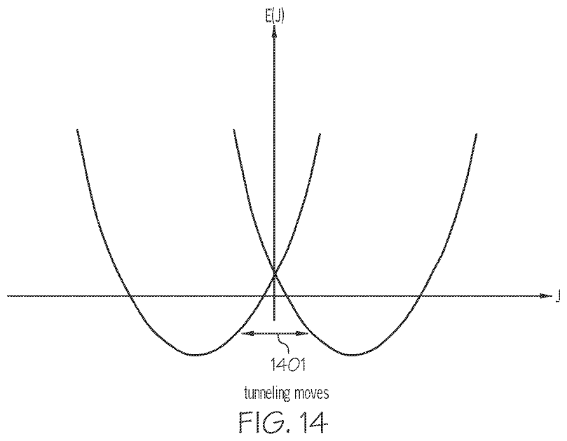

The probability distribution for the test spin s is then given, according to Eq. (43), by:

$$\begin{matrix}{p}_{rtr} ( s ) & ∝ & \int dJ {e}^{{β}^{′} Js} {\sum }_{σ = \pm 1} {e}^{- β E ( σ , J )} p ( σ ) & ( 44 ) \\ & ∝ & \int dJ {e}^{{β}^{′} Js} {\sum }_{σ = \pm 1} {e}^{- β ( J σ - kJ 2 / 2 )} p ( σ ) & ( 45 ) \\ & ∝ & {\sum }_{σ = \pm 1} {e}^{β \frac{{( σ + s {β}^{′} / β )}^{2}}{2 k}} p ( σ ) & ( 46 ) \\ & ∝ & {\sum }_{σ = \pm 1} {e}^{\frac{{β}^{′}}{k} σ s} p ( σ ) & ( 47 ) \\ & ∝ & {\sum }_{σ = \pm 1} ( {δ}_{σ s} + \frac{1}{{e}^{2 {β}^{′} / k} - 1} ) p ( σ ) & ( 48 ) \\ & = & p ( s ) + \frac{1}{{e}^{2 {β}^{′} / k} - 1} & ( 49 )\end{matrix}$$

where δᵢⱼ is the standard Kronecker delta function and Σₛp(s)=1. As shown above, there are several equivalent ways to present the result (see equations above), which highlights its structure. In particular, Eq. (45) explicitly shows that the present generative model can be thought of as providing an Ising-like coupling between the data and test spin, respectively. This simple and lucid expression, however, fails to bring an important aspect explicitly present in the more complicated expression in Eq. (44), i.e., that the intrinsic activation barrier for training is only 1/2k, not the activation energy, 2/k, for the test spin to be excited from the correct to incorrect orientation, at a fixed value of σ. It is reiterated that this activation energy can be enhanced or suppressed by tuning the retrieval temperature T′. From this viewpoint, it may be said that formulating the present generative model in terms of an auxiliary field J in Eq. (41) allows one to significantly reduce the training/retrieval time, even though the generative model has more degrees of freedom. In this case, introducing an extra degree of freedom results in a free energy surface that has a lower transition state than the original problem. Conversely, the original problem can be thought of as a problem where the vibrational ground state for the auxiliary degree of freedom is fixed, as previously alluded to in the above discussion. Also, the symmetry transformation has been previously discussed (See Eq. (10)). It turns out this transformation can also be employed as a Monte Carlo move, whose energy cost is determined exclusively by the data distribution, irrespective of the internal state of the machine. The performance of the present generative model may be improved even further, which further highlights the advantages of using the auxiliary variable J. From the viewpoint of the training energy function, the move (Eq. (10)) occurs under the barrier, which physically can be realized by tunneling as shown in FIG. 14. Thus, such moves of this type will be designated herein as “tunneling.”

FIG. 14 illustrates the graphical illustration of the “tunneling” moves 1401 from Eq. (10) in accordance with an embodiment of the present disclosure.

Equations above offer yet another way to discuss the generative model from Eq. (42). Eq. (47) may be regarded, if so desired, as formally underlying the present generative model. In this model, the test spin is clearly forced to be polarized in the same direction as the corresponding spin representing the data, but is allowed to point in the wrong direction subject to an additional energy penalty 2/k. The latter penalty can be made arbitrarily large, in principle, but not in practice. Now, the variable J can be thought of as the auxiliary variable for a Hubbard-Stratonovich transformation. Such a transformation is used herein as a formal device to decouple interacting degrees of freedom or lower the interaction order—at the expense of introducing the latter auxiliary variable. The latter variable couples linearly to the degrees of freedom being decoupled. In the present context, the decoupling allows one to separate the training and retrieval, per Eq. (44), and thus gives the user choices as to the detailed way of processing and/or sampling the distribution p(J), obtained during training. This freedom is in addition to the aforementioned advantages of using the variable J with regard to the kinetics of training. Hence, for each pattern to be encoded, in the form of the probability of a particular spin configuration, a separate free energy minimum is needed. In the worst case scenario, the number of such minima is 2^{N}, which scales exponentially with the system size.

In any event, the expression for the (un-normalized) distribution (Eq. 49) explicitly shows that the probability distribution for retrieved data approximates the distribution of the original data, where the deviation from correct distribution decays exponentially fast with the reorganization energy needed to bring the two minima of the free energy F(J) fully together. At the same time, the pertinent temperature is not the temperature of the training, but the temperature of the retrieval.

It is observed that the deviation of the retrieved probability distribution from the data is particularly important when either p(σ=+1) or p(σ=−1) is smaller than the last term on the r.h.s. of Eq. (49). The latter term specifies the smallest value for the probability of one of the binary states that can be reliably recorded. In this sense, the quantity [e^{2β′k}−1]⁻¹ can be thought of as an intrinsic amount of noise. To restate this notion in energetic terms, it is noted that when one of the probabilities p(σ)<<1 is small, it is numerically close to the Boltzmann weight of the corresponding state, per Eq. (13):

p(σ)<<1⇒p(σ)≈e^{-β|h|}. (50)

Thus, the condition that the “noise” term does not exceed the weight of the less represented spin state can be expressed in a rather intuitive way:

$$\vert h \vert < \frac{T}{{T}^{′}} \frac{1}{k} . \qquad ( 51 )$$

At the same time, recall that the condition |h|>1/k means being in the Marcus-inverted regime. Thus, a rather lucid criterion is obtained that when the retrieval and training temperature are the same, T′=T, the inverted region corresponds to, essentially, an erasure of the information on the statistics of the less represented state of the data bit. Eq. (51) shows that lowering the retrieval temperature allows one, at least in principle, to rectify some of the error stemming from the overlap of the peaks in the p(J) distribution. In practice, however, it is noted that the J integral in Eq. (43) is dominated by the values of the integration variable |J|=|1±β′/β|/k. At the same time, the values of |J| sampled during training are clustered around J₀±1/k, the corresponding weights given by the p(σ) distribution, per Eq. (16). To assess potential consequences of this circumstance, the continuous integration in Eq. (43) is replaced by a summation over just two values of J₀=±1/k weighted by the probabilities p(σ=±1), respectively. The following are obtained straightforwardly:

$$\text{?} ( s ) ≃ \text{?} p ( σ ) \qquad ( 52 )$$

$$∝ p ( s ) + \frac{1}{{e}^{2 {β}^{′} / k} - 1} \qquad ( 53 )$$

$$\text{?} \text{indicates text missing or illegible when filed}$$

which, note, is the same result as the one obtained using the exact formula. What this is saying is that the configurational equilibration during training is more important than the vibrational equilibration in the sense it is sufficient to sample some places close to the vibrational minima of p(J). At the same time, the sampling bottleneck is determined by the distribution p(σ), as previously discussed. In any event, the results formulated above for a single memory unit motivate one to consider in detail more realistic situations involving substantial amounts of data, not just a single bit.

To this end, a generative model that can be trained over a distribution of an arbitrary number of binary variables is considered. This model will be generalized further to encode for essentially arbitrary correlations in due time. For now, consider the following product of elementary memory units

$$p ( {J}_{1} , … , {J}_{N} ) ∝ {\sum }_{σ 1 , … , σ N} [ {\prod }_{i = 1}^{N} {e}^{β ( {J}_{i} {σ}_{i} - {k}_{i} {J}_{i}^{2} / 2 )} ] p ( {σ}_{i} , … , {σ}_{N} ) ∝ {\sum }_{σ 1 , … , σ N} {e}^{{β}_{i i i i i}^{( J σ - kJ 2 / 2 )}} p ( {σ}_{i} , … , {σ}_{N} ) \qquad ( 54 )$$

c.f. Eqs. (12) and (16), where the binary variables \tilde{σ}ᵢ each can take values +1 or −1 and p(σᵢ, . . . , σₙ) is their combined probability distribution.

The resulting distribution of the test variables s is, then:

$${p}_{rtr} ( {s}_{1} , … , {s}_{N} ) ∝ ( {\prod }_{i = 1}^{N} \int {dJ}_{i} {e}^{{β}^{′} {J}_{i} {s}_{i}} ) p ( {J}_{1} , … , {J}_{N} ) \qquad ( 55 )$$

$$∝ {\sum }_{σ 1 , … , σ N} p ( {σ}_{i} , … , {σ}_{N} ) {e}^{{β}^{′} {\sum }_{i i i i i}^{{β}^{′} σ s / k}} \qquad ( 56 )$$

$$∝ {\sum }_{σ 1 , … , σ N} p ( {σ}_{i} , … , {σ}_{N} ) {\prod }_{i} ( {δ}_{{σ}_{i} {s}_{i}} + \frac{1}{{e}^{2 {β}^{′} / {k}_{i}} - 1} ) \qquad ( 57 )$$

It is observed that just as it was in the case of a single memory unit, the leading asymptotics of the retrieval probability distribution coincide with the data distribution. In a complication, however, the number of error terms is very large and, in fact, scales combinatorially with the size N of a single data sample. Thus, in contrast with the single-unit case, the retrieval probability is dominated by terms other than the correct term. To elucidate potential consequences of this apparent complication, notations are simplified by introducing a new variable:

$${ϵ}_{i} ≡ - {T}^{′} ln \frac{1}{{e}^{2 {β}^{′} / {k}_{i}} - 1} \qquad ( 58 )$$

which has the structure of the vibrational free energy of a quantum harmonic oscillator whose frequency and mass are both proportional to 1/kᵢ while the ground state is set at zero. At the same time, the quantity cᵢ can be thought of as the free energy cost of preventing the loss of information in the data bit i. Indeed, the sum in Eq. (57) can be expanded as a power series in terms of the partition function-like objects e^{-βϵ}ᵢ:

$$( 59 )$$

$${p}_{rtr} ( {s}_{1} , … , {s}_{N} ) ∝ p ( {s}_{i} , … , {s}_{N} ) + {\sum }_{i} {e}^{- {β}^{′} {ϵ}_{i}} {p}^{( 1 )} ( {\{ {s}_{j} \}}_{j \neq i} ) + {\sum }_{i < j} {e}_{}^{- {β}^{′} ( {ϵ}_{i} + {ϵ}_{j} )} {p}^{( 2 )} ( {\{ {s}_{k} \}}_{k \neq i , j} ) + … {\sum }_{i 1 < i 2 < … in} {e}^{- {β}^{′} ( {ϵ}_{i 1} + {ϵ}_{i 2} + {ϵ}_{in} )} {p}^{( n )} ( {\{ {s}_{j} \}}_{j \neq i 1 , i 2 , … , in} ) + …$$

where a reduced probability distribution for the data has been defined as follows:

p⁽¹⁾({σⱼ}_{j≠i})≡Σ_{σi}p(σ₁, . . . ,σᵢ, . . . ,σ_{N}) (60)

p⁽²⁾({σₖ}_{k≠i,j})≡Σ_{σi,σj}p(σ₁, . . . ,σᵢ, . . . ,σⱼ, . . . ,σ_{N}) (61)

p⁽ⁿ⁾({σⱼ}_{j≠i1,i2, . . . in})≡Σ_{σi1, . . . ,σin}p(σ₁, . . . ,σ_{N}) (62)

In other words, to obtain the reduced probability of order n, a correlation function obtained by summing the overall probability distribution of the data over the states of a specific n spins is calculated by construction. The result, then, represents the correlation between the remaining data bits irrespective of the state of those specific n data spins. Since there are N spins total, there are N!/n!(N−n)! distinct reduced probability distributions of order n. Reduced probability distributions are normalized to one. At the same time, since a function p⁽ⁿ⁾ has 2^{(N-n)} terms, it is concluded that, excluding cases when a small number of the terms dominate the distribution, the magnitude of such a reduced probability distribution typically scales as 2^{-(N-n)} and, thus, depends exponentially on n, on the average.

The contributions contained within an individual line in Eq. (59) can be thought of as containing partially coarse-grained information about the data. And so, a function of order n can be thought of as carrying the original data where n out of N data bits have been scrambled. In the context of image recognition, this would correspond to n pixels becoming gray-scale. Since each pixel is assigned a binary value, these gray-scale pixels will end up being assigned a random value thus leading to scrambling the image. Still, the resulting amount of uncertainty for any individual spin depends on the detailed correlations in the data and is not necessarily large. Indeed, suppose for the sake of argument that a given spin is correlated with a mole fraction x of the other spins. The “scrambling” in the vast majority of the n-th order terms, i.e., (N(1−x))!/n!(N(1−x)−n)! or so, will not affect the given spin. Thus, the overall error will be quite small.

Nevertheless, terms of which order generically dominate the complicated sum in Eq. (59) can be established. Indeed, up to an overall multiplicative constant of order 2^{-N}, the following is obtained:

$${p}_{rtr} ∝ {\sum }_{n = 0}^{N} \frac{N !}{n ! ( N - n ) !} {e}^{- n ( {β}^{′} 〈 ϵ 〉 - ln 2 )} , \qquad ( 63 )$$

which has the structure of the partition function for a set of N sites, each of which allows for a doubly-degenerate defect at a cost <ϵ>. Introducing the mole fraction of “defected” sites

$$x ≡ \frac{n}{N} , \qquad ( 64 )$$

and using the standard Stirling approximation, lnn!≈n ln n−n, the following is obtained:

$${p}_{rtr} ∝ {\sum }_{n = 0}^{N} \frac{N !}{n ! ( N - n ) !} {e}^{N [ ( - x ln x - ( 1 - x ) ln ( 1 - x ) + x ( ln 2 - {β}^{′} 〈 ϵ 〉 ) ]} , \qquad ( 65 )$$

assuming x is a small, though not necessarily very small, the above sum is maximized at

x≈2e^{-β″<ϵ>}, (66)
which, in turn, yields, with the help of Eq. (58):

x≈2e^{-2β′<k}^{ᵢ}^{>}. (67)

Thus, noise scales are observed with the extent to which the peaks of the p(J) function overlap. In turn, it is reiterated that this can be directly associated with the amount of activation necessary to learn the data.

A powerful generalization of the memory function p{J} from Eq. (54) can be obtained by noting that in addition to the standalone binary variables σ, arbitrary combinations of σ can be added since the latter are binary quantities as well. Thus, the following is obtained:

$$p ( J ) ∝ {\sum }_{{σ}_{1} , … , {σ}_{N}} {e}^{- β {E}_{tr}} p ( {σ}_{i} , … , {σ}_{N} )$$

where J is the full set of coupling constants that enter the (training) energy function constructed according to the following expression:

$${E}_{tr} ≡ {\sum }_{i} ( - {J}_{i} {σ}_{i} + {k}_{i} {J}_{i}^{2} / 2 ) + {\sum }_{i < j} ( - {J}_{ij} {σ}_{i} {σ}_{j} + {k}_{ij} {J}_{ij}^{2} / 2 ) + {\sum }_{i < j < k} ( - {J}_{ijk} {σ}_{i} {σ}_{j} {σ}_{k} + {k}_{ijk} {J}_{ijk}^{2} / 2 ) + … \qquad ( 68 )$$

and so on, up to rank-N interaction, in principle. The total number of coupling constants is, then, 2^{N} which allows one to encode the statistic of every single state out of the maximum total of the distinct 2^{N} configuration that are, in principle, available to N spins representing the data.

The rank-one expression from Eq. (57) is straightforwardly generalized to include interactions of arbitrary order:

$${p}_{rtr} ( s ) ∝ \int {d}^{2 N} Jp ( J ) {e}^{{β}^{′}} ( {\sum }_{i} {J}_{i} {s}_{i} + {\sum }_{i < j} {J}_{ij} {s}_{i} {s}_{j} + {\sum }_{i < j < k} {J}_{ijk} {s}_{i} {s}_{j} {s}_{k} + … ) \qquad ( 69 )$$

$$∝ \sum {}_{σ} p ( σ ) {e}^{{β}^{′}} ( {\sum }_{i} {σ}_{i} {s}_{i} / {k}_{i} + {\sum }_{i < j} {σ}_{i} {σ}_{j} {s}_{i} {s}_{j} / {k}_{ij} + {\sum }_{i < j < k} {σ}_{i} {σ}_{j} {σ}_{k} {s}_{i} {s}_{j} {s}_{k} / {k}_{ijk} + … ) \qquad ( 70 )$$

$$( 71 )$$

$$∝ \sum {}_{σ} p ( σ ) {\prod }_{i} ( {δ}_{{σ}_{i} , {s}_{i}} + \frac{1}{{e}^{2 {β}^{′} / {k}_{i}} - 1} ) {\prod }_{i < j} ( {δ}_{{σ}_{i} {σ}_{j} {s}_{i} {s}_{j}} + \frac{1}{{e}^{2 {β}^{′} / {k}_{ij}} - 1} ) \times {\prod }_{i < j < k} ( {δ}_{{σ}_{i} {σ}_{j} {σ}_{k} , {s}_{i} {s}_{j} {s}_{k}} + \frac{1}{{e}^{2 {β}^{′} / {k}_{ijk}} - 1} ) \times …$$

where s=(s₁, s₂, . . . , s_{N}) is the full set of the test spin variables. It is noted that a comma is used to clearly separate the two arguments in the Kronecker delta function. It is further noted that in those cases where the list of spin variables in the delta functions has more than 2 spins, the comma can be put anywhere. Finally, it is noted that, in principle, retrieval temperatures are employed for terms of distinct order.

The following discusses numerical tests.

In particular, the following discusses numerical tests in connection with the simplest memory unit.

Per Eq. (69), retrieval in the present model is technically an integration over the probability distribution p(J) as resulting from training over specific data sets. The retrieved probability distribution has a built-in error, due to using a non-vanishing value of k. In addition, the integration over the auxiliary variables J is performed approximately, in practice, which may cause additional error. Finally, it is worth investigating the effects of varying the retrieval temperature T″. At a first glance, using low values of T′ should be beneficial because it can, in principle, allow one to partially reconstruct information in the Marcus-inverted regime by accessing extremities of obscured peaks in the p(J) distribution. In practice, large values of the quantity β′Js in the exponent present risks of numerical error when sufficiently large values of J are sampled. In the following, numerical tests are provided, using a modest number of simple problems, which will reflect those three aspects of the present approach.

One problem is the one-spin problem in which the data is represented by a single binary variable σ±1. For concreteness, the relative probability for the two states is set at:

$$\frac{p ( σ = + 1 )}{p ( σ = - 1 )} = \frac{0.9}{0.1} \qquad ( 72 )$$

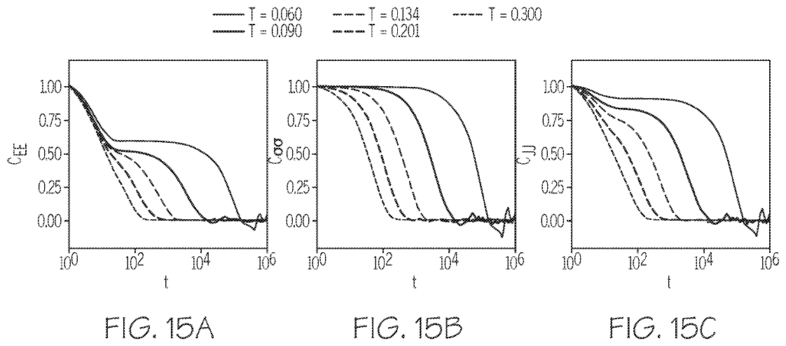

The underlying energy function for this distribution is E=−hσ, where h=T ln (0.90.1)/2. First, several two-point correlation functions are shown, analogously to the h=0 case in FIGS. 15A-15C.

FIGS. 15A-15C illustrate the normalized auto-correlation functions for the simplest memory unit in accordance with an embodiment of the present disclosure. In connection with FIGS. 15A-15C, k=1, p(σ=+1) p(σ=−1)=0.9/0.1.

It is observed that the activated dynamics, including in the energy function, has become apparent in the presence of a non-vanishing bias. In this simulation, moves σ→−σ, and J→J+ΔJ have been employed. The value of ΔJ is chosen to be at the optimum value per prescription for sampling the normal distribution since this is the probability distribution for J at a fixed value of σ.

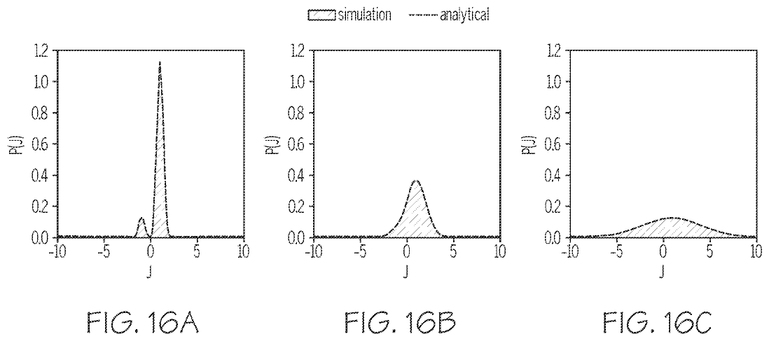

The trained p(J) is shown in FIGS. 16A-16C for three values of the temperature in accordance with an embodiment of the present disclosure, while k=1, which covers the full set of possibilities from the two peaks being completely resolved to largely coinciding. In connection with FIGS. 16A-16C, p(J) for p(σ=+1)/p(σ=−1)=0.9/0.1. In connection with FIG. 16A, Tₜᵣ=0.1. In connection with FIG. 16B, Tₜᵣ=1.0. In connection with FIG. 16C, Tₜᵣ=10.0.

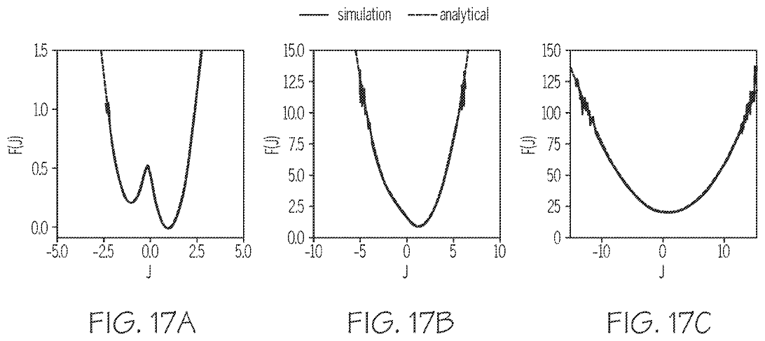

The corresponding free energy profiles F(J)=−T lnp(J) are shown in FIGS. 17A-17C in accordance with an embodiment of the present disclosure. In connection with FIGS. 17A-17C, F(J) for p(σ=+1)/p(σ=−1)=0.9/0.1. In connection with FIG. 17A, Tₜᵣ=0.1. In connection with FIG. 17B, Tₜᵣ=1.0. In connection with FIG. 17C, Tₜᵣ=10.0.

FIGS. 17A-17C allow one to assess the size of the space explored by the auxiliary field J, as a result of Monte Carlo sampling, more directly when using p(J) because in the latter case, the tails on the flanks of the distribution are already too thin in the first place.

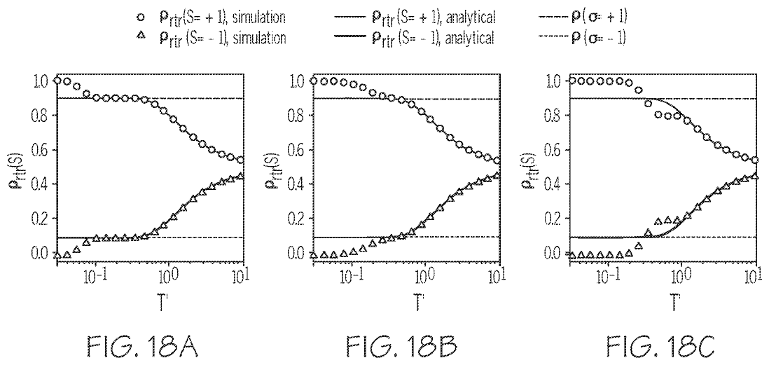

Next, the values of the variable J that were sampled during training are used to retrieve the distribution of the test spin s, per formula (Eq. (43)). The full duration of the training (once equilibrium was achieved) was used, i.e., 10 steps. The three cases shown correspond with those same three emblematic cases from FIGS. 16A-16C and 17A-17C. It is observed that the exact result from Eq. (39) is recovered in all cases so long as the retrieval temperature is comparable to or higher than the training temperature as illustrated in FIGS. 18A-18C. Yet only when the two minima in the F(J) function are well resolved can the original distribution of the data be recovered in a meaningfully broad range of the retrieval temperature, as expected.

FIGS. 18A-18C illustrate pᵣₜᵣ(s) as a function of retrieval temperature T′ in accordance with an embodiment of the present disclosure. In connection with FIGS. 18A-18C, p(σ=+1)/p(σ=−1)=0.9/0.1. In connection with FIG. 18A Tₜᵣ=0.1. In connection with FIG. 18B, Tₜᵣ=1.0. In connection with FIG. 18C, Tₜᵣ=10.0.

The divergence of the retrieved probabilities from their ideal values expected at low retrieval temperature is due to numerical issues and becomes more likely at longer sampling times. What happens is that the exponential e^{βsJ} can become uncharacteristically large when β′ is significantly greater than β resulting in a single sampling of the exponential dominating the total and thus skewing the overall result. At the same time, short sampling times do not produce adequate sampling for purely statistical reasons. These notions can be supported by the data and some remedy can be proposed, as discussed below.

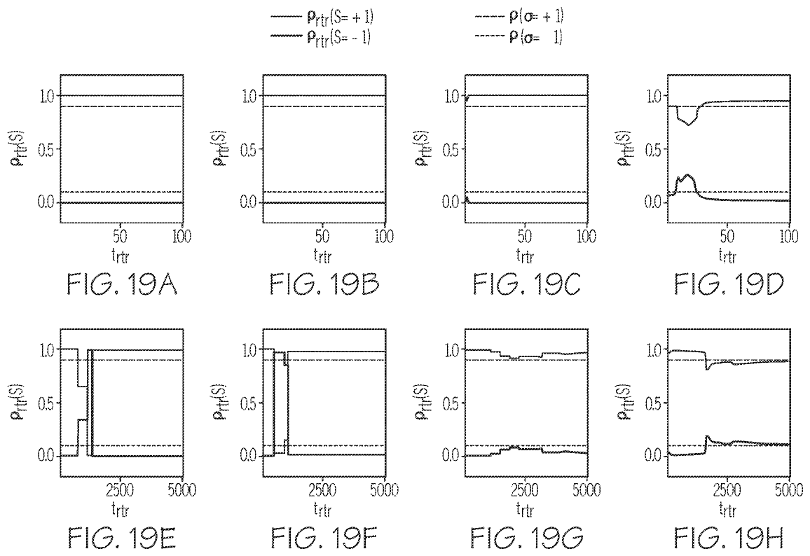

Referring now to FIGS. 19A-19H, FIGS. 19A-19H illustrate the time traces of the retrieved probabilities p(s) for four specific values of T′ and two values of the duration of the sampling, starting from some equilibrium configuration, in accordance with an embodiment of the present disclosure. It is observed that in some cases, the probabilities are clearly dominated by one minimum of the p(J) surface.

Referring again to FIGS. 19A-19H, FIGS. 19A-19H illustrate pᵣₜᵣ(s) as a function of retrieval time, where T_{tr r}=0.1. Furthermore, FIGS. 19A-19D have a shorter retrieval time, whereas, FIGS. 19E-19H have a longer retrieval time. The retrieval temperature, Tᵣₜᵣ, in FIGS. 19A, 19E is 0.03. The retrieval temperature, Tᵣₜᵣ, in FIGS. 19B, 19F is 0.1. The retrieval temperature, Tᵣₜᵣ, in FIGS. 19C, 19G is 0.3. The retrieval temperature, Tᵣₜᵣ, in FIGS. 19D, 19H is 0.5.

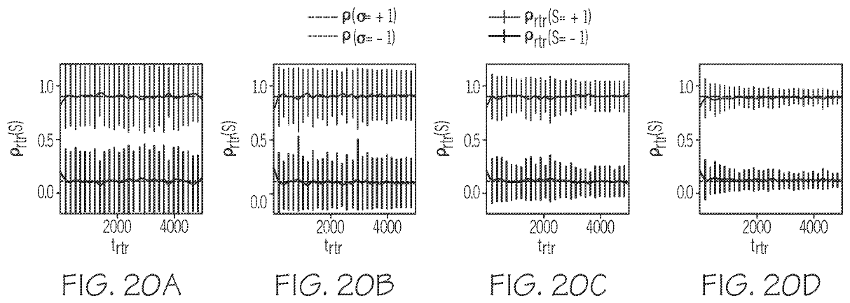

These issues can be partially ameliorated by averaging over many runs. FIGS. 20A-20D illustrate the result of such averaging over 200 hundred runs. In particular, FIGS. 20A-20D illustrate retrieval probabilities pᵣₜᵣ(s) averaged over 200 stretches of training runs in accordance with an embodiment of the present disclosure. The corresponding RMSD (root mean square deviation) is indicated as the vertical bar. Furthermore, Tₜᵣ=0.1. In FIG. 20A, the retrieval temperature, Tᵣₜᵣ, is 0.03. In FIG. 20B, the retrieval temperature, Tᵣₜᵣ, is 0.1. In FIG. 20C, the retrieval temperature, Tᵣₜᵣ, is 0.3. In FIG. 20D, the retrieval temperature, Tᵣₜᵣ, is 0.5.

It is observed that the system now does sample near the vicinities of the asymptotically correct values for the retrieval probabilities.

Now, it is illustrated how an improvement in terms of the speed of training can be achieved. In one embodiment, the spin flip moves σ→−σ by a compound move from Eq. (10), which is reproduced here for convenience:

J,σ→−J,−σ (73)

Clearly replacing the simple spin flip with the compound move above does not violate ergodicity since the J variable is still allowed to move all by itself. The difference now is that a pure spin flip move now becomes less likely since it requires a sequence of at least two moves. Per the earlier discussion, the move (Eq. (73)) is designated as the “tunneling” move. Furthermore, the “biased” one bit problem is continued from Eq. (72). As expected, the speedup in training exceeds a factor of thousand.

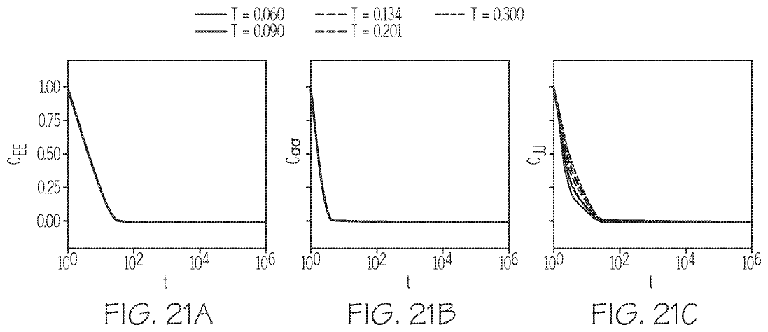

FIGS. 21A-21C illustrate normalized auto-correlation functions of the simplest memory unit, with tunneling, in accordance with an embodiment of the present disclosure. In connection with FIGS. 21A-21C, k=1. Furthermore, in connection with FIGS. 21A-21C, p(σ=+1) p(σ=−1)=0.9/0.1.

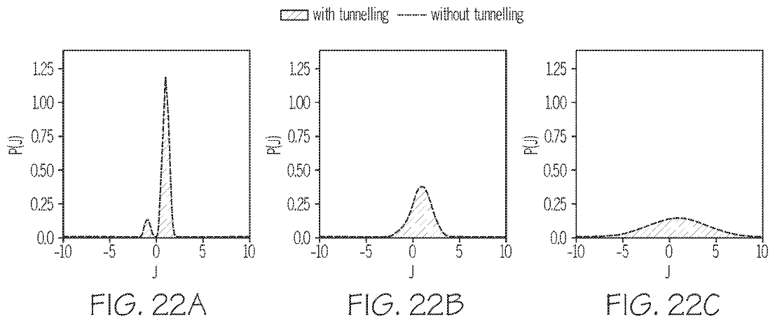

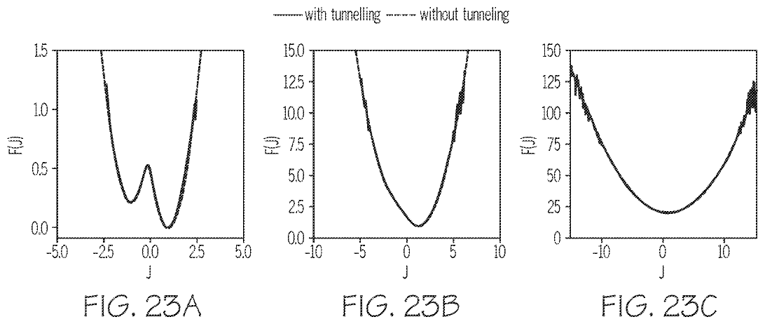

The corresponding p(J) distribution and free energy surface F(J) are shown in FIGS. 22A-22C and 23A-23C, respectively. These Figures directly show ergodicity is indeed preserved with the new move set.

FIGS. 22A-22C illustrate the probability distribution p(J) for a single memory unit, p(σ=+1)/p(σ=−1)=0.9/0.1, obtained using the tunneling move in accordance with an embodiment of the present disclosure. In connection with FIG. 22A Tₜᵣ=0.1. In connection with FIG. 22B, Tₜᵣ=1.0. In connection with FIG. 22C, Tₜᵣ=10.0.

FIGS. 23A-23C illustrate the free energy F(J) for p(σ=+1) p(σ=−1)=0.9/0.1, with tunneling, in accordance with an embodiment of the present disclosure. In connection with FIG. 23A Tₜᵣ=0.1. In connection with FIG. 23B, Tₜᵣ=1.0. In connection with FIG. 23C, Tₜᵣ=10.0.

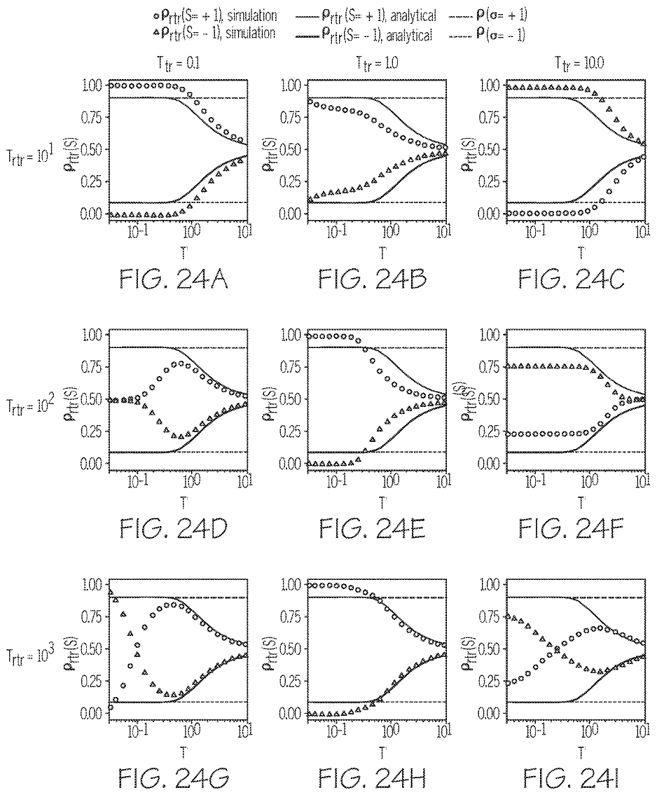

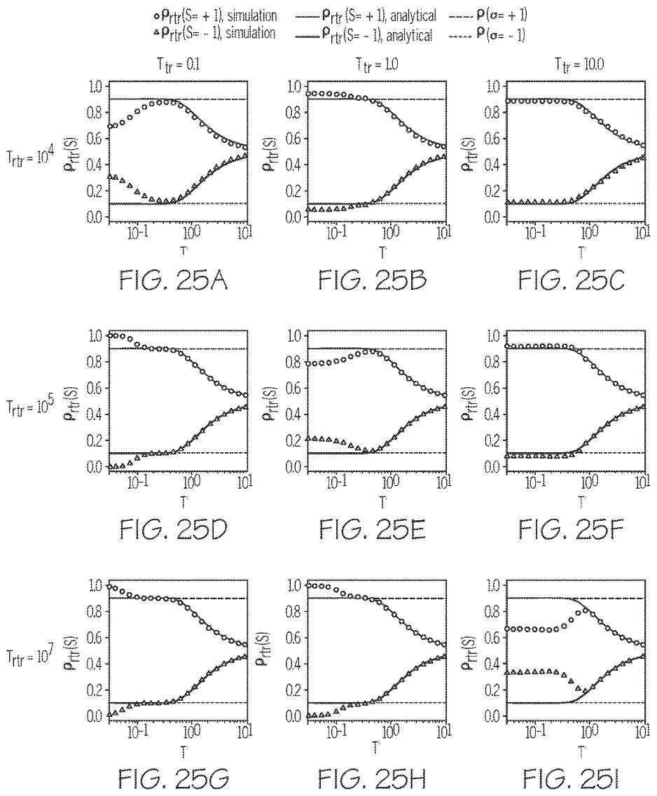

FIGS. 24A-24I and FIGS. 25A-25I illustrate how the quality of retrieval changes with the training time. FIGS. 24A-24I illustrate pᵣₜᵣ(s) as a function of retrieval time and temperature, with tunneling, in accordance with an embodiment of the present disclosure. As illustrated in FIGS. 24A-24I, the latter time reflects how many realizations of the configurations of the field J may be used for computing the retrieval probability from Eq. (69). In connection with FIGS. 24A-24I, k=1 and p(σ=+1)/p(σ=−1)=0.9/0.1. Furthermore, Tᵣₜᵣ=10 in FIGS. 24A-24C. Tᵣₜᵣ=100 in FIGS. 24D-24F. Tᵣₜᵣ=1,000 in FIGS. 24G-24I. Furthermore, Tₜᵣ=0.1 for FIGS. 24A, 24D, 24G. Additionally, Tₜᵣ=1.0 for FIGS. 24B, 24E, 24H. Furthermore, Tₜᵣ=10.0 for FIGS. 24C, 24F, 24I.

FIGS. 25A-25I illustrate pᵣₜᵣ(s) as a function of retrieval time and temperature, with tunnelling, in accordance with an embodiment of the present disclosure. The retrieval time is longer compared with FIGS. 24A-24I. In connection with FIGS. 25A-25I, k=1 and p(σ=+1)/p(σ=−1)=0.9/0.1. Furthermore, Tᵣₜᵣ=10,000 in FIGS. 25A-25C. Tᵣₜᵣ=100,000 in FIGS. 25D-25F. Tᵣₜᵣ=10,000,000 in FIGS. 25G-25I. Furthermore, Tₜᵣ=0.1 for FIGS. 25A, 25D, 25G. Additionally, Tₜᵣ=1.0 for FIGS. 25B, 25E, 25H. Furthermore, Tₜᵣ=10.0 for FIGS. 25C, 25F, 25I.

It is observed that while a relatively modest number of samplings is necessary to begin to recover the analytical expression from Eq. (39) at relatively high values of the retrieval temperature, significantly more moves are necessary to recover the actual probability distribution of the data that pertains to low values of both the training and retrieval temperatures.

It has been shown that numerical issues at low values of the retrieval temperature are caused by occasional sampling of large values of the auxiliary variable J. There is a way to, quite literally, rectify this situation. For example, instead of immediately using the actual value of J as sampled during the training run, the variable J is vibrationally relaxed before using it for retrieval. In the present context, this implies the following, simplified expression for the retrieval probability to be used, c.f. the discussion leading to Eq. (42):

pᵣₜᵣ(s)=∫dJp(J)e^{β′σ(J)/k} (74)

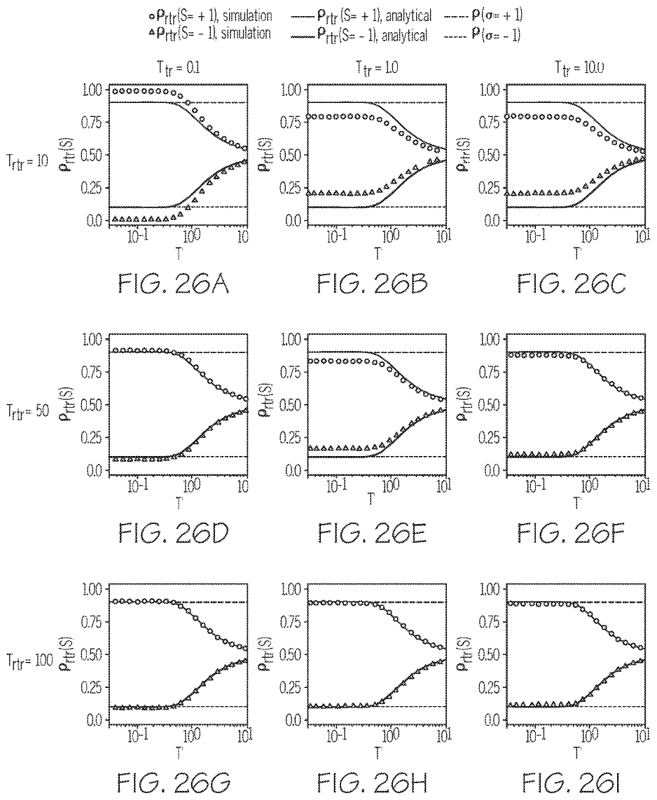

FIGS. 26A-26I indicate that the performance is indeed dramatically improved and now becomes limited exclusively by how fast the data distribution is sampled during training, not the relaxation of the machine itself. FIGS. 26A-26I illustrate pᵣₜᵣ(s) as a function of retrieval duration and temperature, with tunneling, in accordance with an embodiment of the present disclosure. In connection with FIGS. 26A-26I, pᵣₜᵣ (s)≡∫dJp(J) e^{β′sσ(J)/k}. k=1, p(σ=+1)/p(σ=−1)=0.9/0.1. Furthermore, Tᵣₜᵣ=10 in FIGS. 26A-26C. Tᵣₜᵣ=50 in FIGS. 26D-26F. Tᵣₜᵣ=100 in FIGS. 26G-26I. Furthermore, Tₜᵣ=0.1 for FIGS. 26A, 26D, 26G. Additionally, Tₜᵣ=1.0 for FIGS. 26B, 26E, 26H. Furthermore, Tₜᵣ=10.0 for FIGS. 26C, 26F, 26I.

The following discusses a multi-expert situation, using a somewhat more complicated pattern.

This pattern involves three spins. By construction, the underlying energy function involves exclusively a three-spin interaction:

E(σ₁,σ₂,σ₃)=−h₁₂₃σ₁σ₂σ₃ (75)
where the following is set for concreteness:

$${h}_{123} = \frac{T}{2} ln ( \frac{0.9}{0.1} ) . \qquad ( 76 )$$

$$c . f . Eq . \qquad ( 72 )$$

According to this energy function, nine out of ten times, on the average, the data conforms to a pattern that can be summarized using the following table (Table 1) and one out of ten times, the data follows the complementary pattern.

TABLE 1

| | | |
|---|---|---|
| | ↑ | ↓ |
| ↑ | ↑ | ↓ |
| ↓ | ↓ | ↑ |

Table 1 depicts four out of eight configurations for the three spins from Eq. (75).
Table 2, shown below, depicts four configurations complementary to the configurations in Table 1.

TABLE 2

| | | |
|---|---|---|
| | ↑ | ↓ |
| ↑ | ↓ | ↑ |
| ↓ | ↑ | ↓ |

Here any two of the three spins are considered as the two arguments of the table and the four entries of the table provide the value of the third spin.

It is noted that Table 1 is mathematically equivalent to the group multiplication table for a number of simple groups, such as for reflection symmetry or the permutation group S₂, as shown in Tables 3 and 4, respectively, or, in the Ising-spin representation.

The less likely option, from Table 2, is equivalent to the binary XOR operation, which is of direct interest for digital computation.

TABLE 3

| | | |
|---|---|---|
| | e | a |
| e | e | a |
| a | a | e |

Table 3 is a group multiplication table for the reflection symmetry group.

TABLE 4

| | | |
|---|---|---|
| | 1 | −1 |
| 1 | 1 | −1 |
| −1 | −1 | 1 |

Table 4 is a numerical representation of the group multiplication Table 3.

In one embodiment, the machine will be asked to reproduce the data distribution corresponding to the underlying energy function (Eq. (75)). Throughout, the tunneling move is employed, whereby whenever a spin is flipped, all the J's that are coupled to the spin will have their signs simultaneously flipped as well.

First it is considered, as the training model, an energy function that contains exclusively rank-one interactions, i.e., exclusively on-site fields:

$${E}_{rtr} = - {J}_{1} {σ}_{1} - {J}_{2} {σ}_{2} - {J}_{3} {σ}_{3} + {\sum }_{i} \frac{{kJ}_{i}^{2}}{2} . \qquad ( 77 )$$

where for simplicity the same force constant is used for all three auxiliary fields. In a sense, the above generative model represents the worst case scenario because an individual configuration of the J's can produce only one out of eight possible configurations as its ground state.

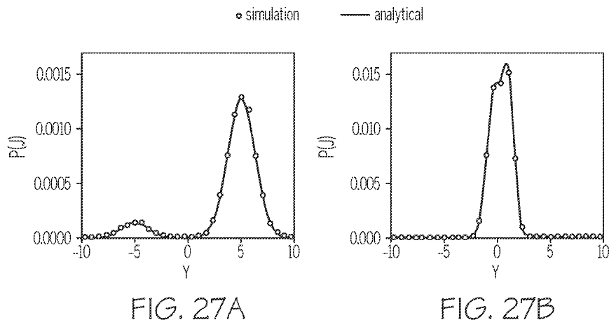

The resulting probability distributions for the on-site fields are illustrated in FIGS. 27A-27B where the three-dimensional space (J₁, J₂, J₃) is scanned along the diagonal of one of the faces of the cube formed by the positions of the vibrational minima of the J vector. The two cases shown in FIGS. 27A-27B correspond to the peaks being well resolved and poorly resolved.

FIGS. 27A-27B illustrate p(J) along the space diagonal of a J-cube in accordance with an embodiment of the present invention. In connection with FIGS. 27A-27B, γ is the indicator on the diagonal with J=γ(1, 1, 1). Furthermore, in connection with FIGS. 27A-27B, Tₜᵣ=1. Additionally, k=0.2 in FIG. 27A and k=1.0 in FIG. 27B.

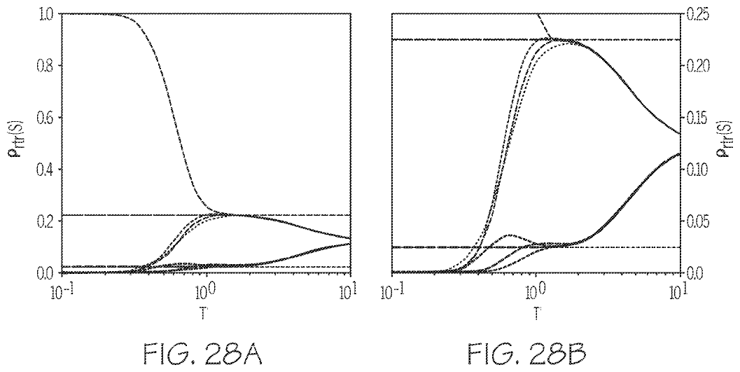

The retrieval probabilities are shown for the well-resolved case in FIGS. 28A-28B.

FIGS. 28A-28B illustrate pᵣₜᵣ(s) as a function of the retrieval temperature T′ for the well-resolved case in accordance with an embodiment of the present disclosure. In connection with FIGS. 28A-28B, Tₜᵣ=1 and k=0.2

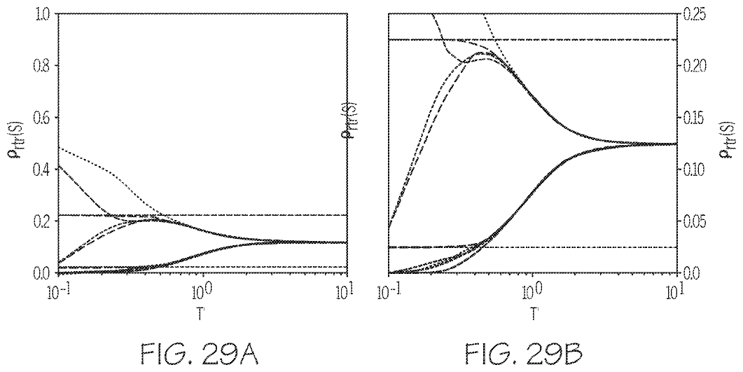

The retrieval probabilities for the poorly-resolved case is shown in FIGS. 29A-29B. FIGS. 29A-29B illustrates pᵣₜᵣ(s) as a function of the retrieval temperature T′ for the poorly-resolved case in accordance with an embodiment of the present disclosure. In connection with FIGS. 29A-29B, Tₜᵣ=1 and k=1.

As a result of the foregoing, it can be concluded that even though the generative model in Eq. (77) is incorrect, interrogating a sufficient number of configurations of the fields docs produce the distribution of the data. One can informally designate each sampling of the fields J, as produced during training, as an expert inquiry. Hence, it can be concluded, consistent with the previously considered 1-spin problem, that inquiring a sufficient number of experts will produce an acceptable distribution of data, even if an individual expert reproduces only a fraction of the overall pattern contained in the data.

Next is considered the correct generative model:

$${E}_{rtr} = - {J}_{123} {σ}_{1} {σ}_{2} {σ}_{3} + \frac{{kJ}_{123}^{2}}{2} . \qquad ( 78 )$$

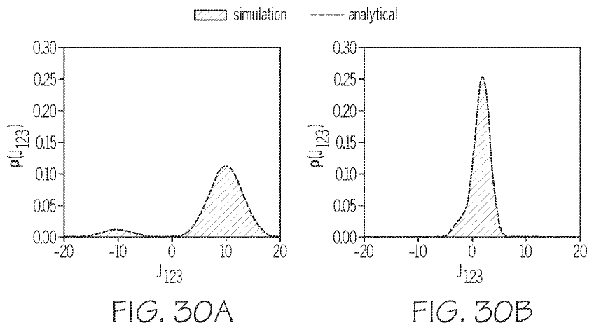

The corresponding p(J₁₂₃) distribution is shown in FIGS. 30A-30B. FIGS. 30A-30B illustrate p(J₁₂₃) for the generative model (Eq. (78)) in accordance with an embodiment of the present disclosure. In connection with FIGS. 30A-30B, Tₜᵣ=1. In connection with FIG. 30A, k=0.1. In connection with FIG. 30B, k=0.5.

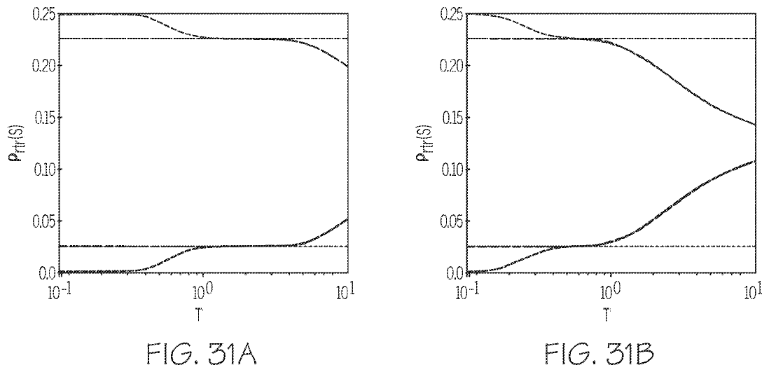

This model does much better, as expected, and readily reproduces the correct data distribution within a broad range of retrieval temperatures, as demonstrated in FIGS. 31A-31B.

FIGS. 31A-31B illustrate p(s) for the generative model (Eq. (78)) in accordance with an embodiment of the present disclosure. In connection with FIGS. 31A-31B, Tₜᵣ=1. In connection with FIG. 31A, k=0.1. In connection with FIG. 31B, k=0.5.

The following provides a discussion regarding the dichotomous problem.

Of separate significance is the strictly dichotomous limit of the problem previously considered, whereby only the ground state of the generative model (Eq. (75)) is encountered in the data. In other words, the machine is simply being asked to memorize the multiplication table or the XOR table. The former was chosen for concreteness. The dichotomous case is less general, but is more intuitive, since in this case, only four out of possible spin configurations are considered strictly “correct,” and the rest four strictly “incorrect.”

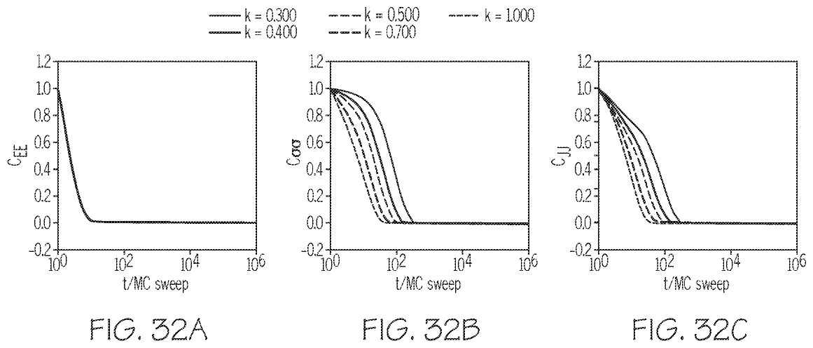

The correlation functions are shown in FIGS. 32A-32C, which clearly exhibit activation.

FIGS. 32A-32C illustrate normalized auto-correlation functions from HCBN simulation with different k values in accordance with an embodiment of the present disclosure. In connection with FIGS. 32A-32C, only rank 1 interactions are included in the energy function. Furthermore, in connection with FIGS. 32A-32C, T=1.

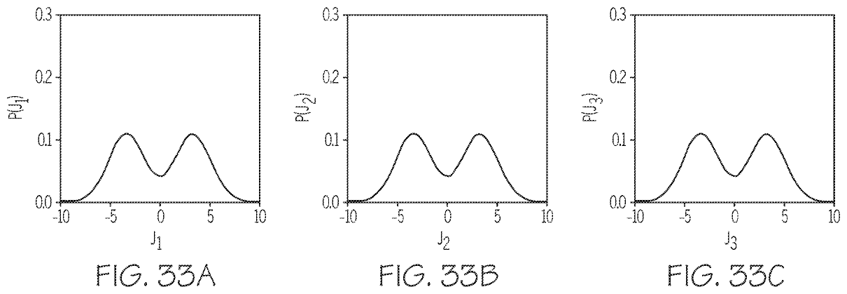

Next, the coupling constants are plotted in a histogram, each of which exhibits a bimodal distribution, implying one-body energy terms do not show overall preference for the correct configurations, as shown in FIGS. 33A-33C.

FIGS. 33A-33C illustrate the distribution of J from the simulation in accordance with an embodiment of the present disclosure. It is noted that only rank 1 interactions are included in the energy function. Furthermore, in connection with FIGS. 33A-33C, T=1 and k=0.3

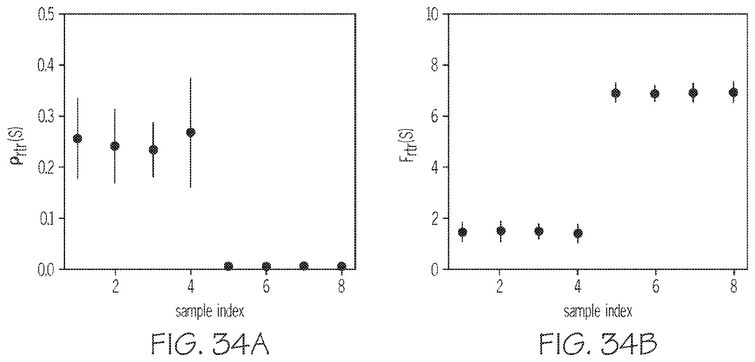

The long-term performance, retrieval-wise is shown in FIGS. 34A-34B, in terms of retrieval probability (FIG. 34A) and the corresponding free energy difference (FIG. 34B), which is simply the negative log probability times temperature.

FIGS. 34A-34B illustrate the retrieval probability and free energy of different samples in accordance with an embodiment of the present disclosure. In connection with FIGS. 34A-34B, k=0.3 and T=1.

It has been observed that at long times, the correct configurations dominate the phase space of the system.

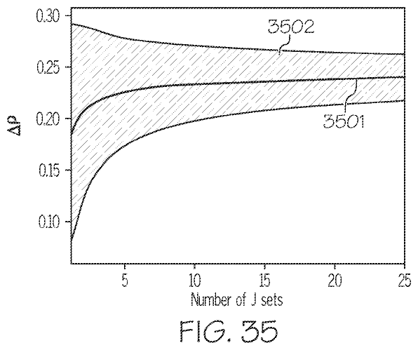

The free energy perspective on the retrieval quality is helpful from the viewpoint commonly accepted in energy-based machine learning methodologies. There, the goal is to separate correct from incorrect patterns by spacing them out in terms of an energy. Correct configurations correspond to low energies and incorrect to high energies. The present approach is intrinsically finite-temperature, and so the appropriate energy-like quantity is the free energy. Importantly, both the energy of an individual internal state of the machine and the multiplicity of states with the same energy, contribute to the entropy of the system. That surveying a substantial number of internal states is important for the performance can be directly seen in how the probability “gap” between correct and incorrect configuration depends on the number of inquiries of individual J-configurations, as shown in FIG. 35.

FIG. 35 illustrates the probability gap between correct and incorrect retrievals in accordance with an embodiment of the present disclosure. The x axis is the number of J sets used for retrieval. The solid line 3501 is the average probability gap, and the shaded area 3502 is the error. Furthermore, in connection with FIG. 35, T=1 and k=0.3.

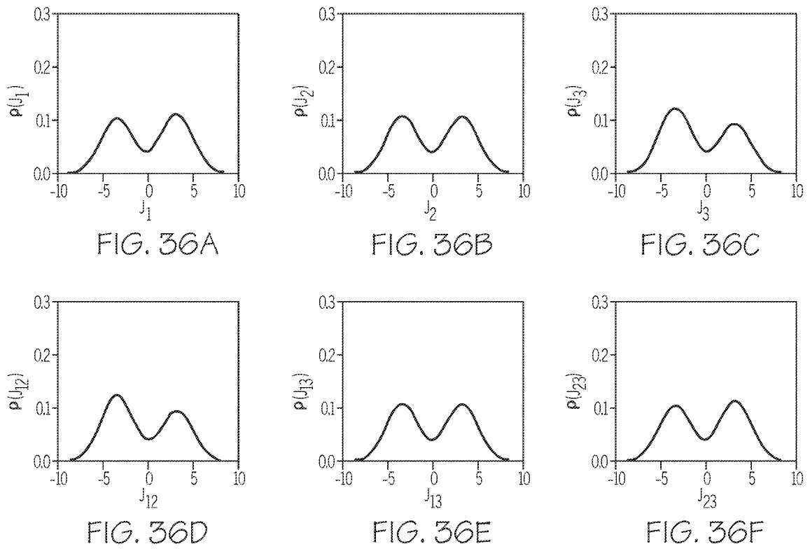

Similar behavior is seen, when rank-two interactions are added to the generative model. The histogram of the coupling constants are shown in FIGS. 36A-36F.

FIGS. 36A-36F illustrate the distribution of J from the simulation in accordance with an embodiment of the present disclosure. Rank 1&2 interactions are included in the energy function. In connection with FIGS. 36A-36F, T=1 and k=0.3.

Like in the rank-one only case, the coupling constants are equally likely to be positive or negative. Thus, no individual energy function can capture the full pattern. One needs multiple such functions to reproduce the full set of data.

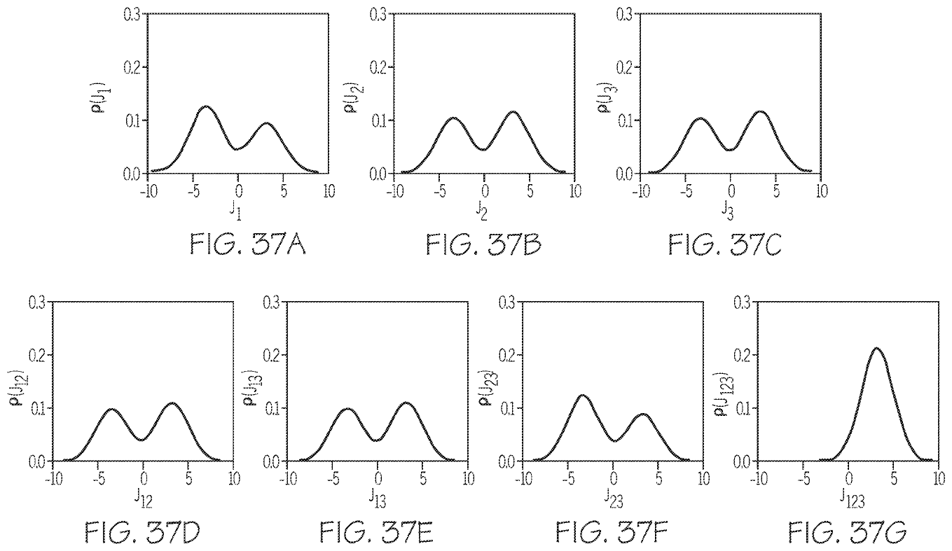

Only adding the rank-three interaction reveals a pattern. According to the histograms in FIGS. 37A-37G, the rank-three coupling is selective toward the pattern, as expected.

FIGS. 37A-37G illustrate the distribution of J from the simulation in accordance with an embodiment of the present disclosure. Interactions up to rank 3 are included in the energy function. In connection with FIGS. 37A-37G, T=1 and k=0.3.

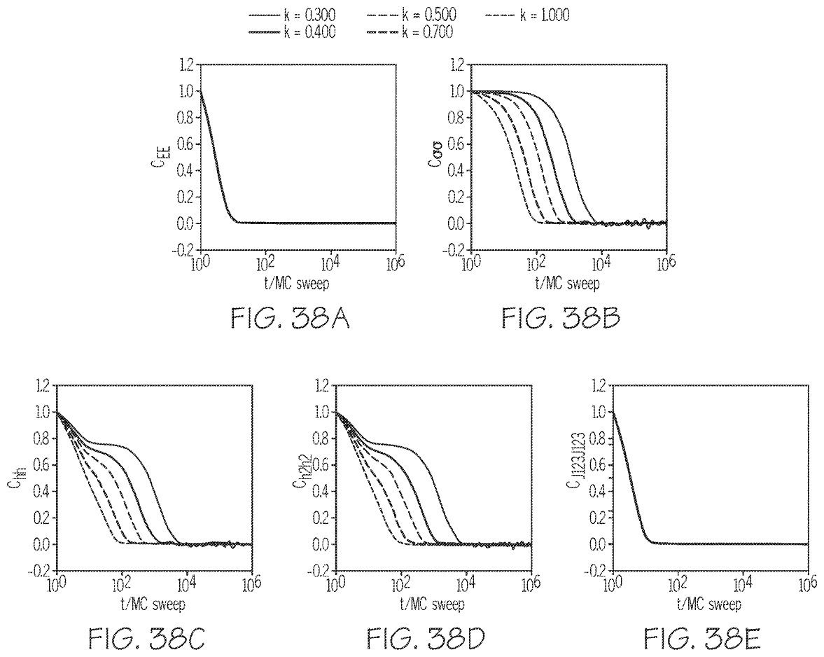

There are important consequences of this fact for the kinetics of training. Per FIGS. 38A-38E, the J₁₂₃-J₁₂₃ correlation function is the only one, other than the energy-energy one, that does not show configurational dynamics, consistent with the free energy having just one minimum along the J₁₂₃ direction.

FIGS. 38A-38E illustrate the normalized auto-correlation functions from the HCBN simulation with different k values in accordance with an embodiment of the present disclosure. In connection with FIGS. 38A-38E, T=1. FIG. 38A illustrates the energy auto-correlation function. Interactions up to rank 3 are included in the energy function. FIG. 38B illustrates the σ₁ auto-correlation function. FIG. 38C illustrates the J₁ auto-correlation function. FIG. 38D illustrates the J₁₂ auto-correlation function. FIG. 38E illustrates the J₁₂₃ auto-correlation function.

When there is needed only one underlying function while its ground state can cover every single “correct” configuration, as is the case for the strictly dichotomous table problem above, such a situation is the simplest possible situation. In such cases, only vibrational relaxation is needed. This ideal situation can be designated as one requiring only one expert.

The following discusses a graphic summary of how the same generative model can exhibit behaviors ranging from a one-expert to a multi-expert situations. As already discussed many times, the value of the spring constants k can be tuned to change the separation among the free energy minima on the F(J) surface or, equivalently, among the corresponding maxima on the p(J) surface.

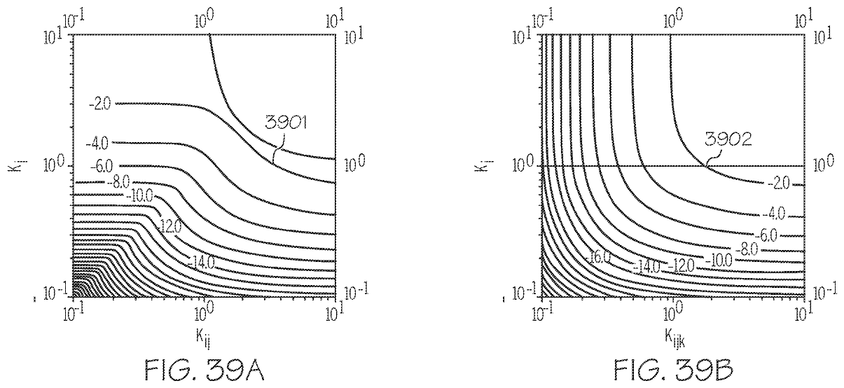

The p(J) surface has been analyzed for certain underlying energy functions while, at the same time, keeping track of the free energy gap between the correct and incorrect solutions. The result of this combined study for a family of energy functions that have only rank-one and rank-two interactions is shown in FIGS. 39A-39B.

FIGS. 39A-39B illustrate the free energy gap contour map with different k values in accordance with an embodiment of the present disclosure. As shown in FIGS. 39A-39B, curve 3901, 3902 separate the single-expert and multi-expert area, respectively. In connection with FIG. 39A, the training energy function has rank 1&2 interactions. The upper right corner corresponds to one expert but exhibits a small free energy gap. In connection with FIG. 39B, the training energy function has rank 1&3 interactions. The upper half corresponds to a single expert and has a large free energy gap for small k₁₂₃.

Furthermore, FIG. 39A illustrates the topographical map of the free energy gap as a function of the spring constant k₁ and k₂ for the rank-one and rank-two J's, respectively. Line 3901 delineates the one-expert regime, which is the upper-right corner, from the multi-expert regime. It is observed that the one-expert regime can be obtained without the rank-three interaction, however, the free energy gap is small so that the stability of the correct configurations, relative to the incorrect ones, is not great. Conversely, to achieve a greater gap, multiple experts are used, consistent with earlier findings. In FIG. 39B, there are interactions of rank one and rank three, the latter one being the correct interaction. Here the one-expert regime is the top portion above line 3902. It is observed that in this case, the gap can be made arbitrarily large while in the single expert regime.

The following discusses deep networks in connection with capturing complex patterns using simple network morphologies.

It has been shown that the inclusion of the rank-three interaction is important for the optimal performance of a simple problem involving three spins. This trend may be rather general and, hence, pose computational challenges since the space of all possible multi-spin interactions grows combinatorially with the interaction's rank. At the same time, there have been successes of solving certain problems of practical significance using artificial, deep neural networks. Yet the corresponding energy functions are exclusively two-rank. Motivated by this notion, possibility that hidden spins could effectively generate high-rank interactions among the visible spins that directly represent the data is investigated.

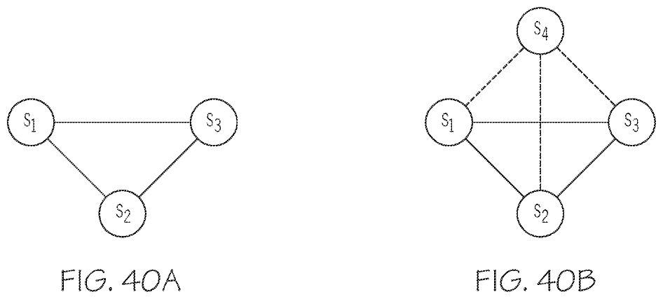

For concreteness, the setup is graphically shown in FIGS. 40A-40B.

FIG. 40A illustrates visible spins in accordance with an embodiment of the present disclosure. FIG. 40B illustrates a fourth, added hidden spin in accordance with an embodiment of the present disclosure.

Consider an energy function for the three-spin system from FIG. 40A that contains only interactions of rank one and rank two, but not rank three:

E=−J₁₂s₁s₂−J₁₃s₁s₃−J₂₃s₂s₃−h₁^{(ext)}s₁−h₂^{(ext)}s₂−h₃^{(ext)}s₃ (79)

Now a 4-th, “hidden” spin, s₄, is added which interacts with the visible spins only via pair-wise, 2-body couplings:

E=−J₁₂s₁s₂−J₁₃s₁s₃−J₂₃s₂s₃−h₁^{(ext)}s₁−h₂^{(ext)}s₂−h₃^{(ext)}s₃−s₄(J₁₄s₁+J₂₄s₂+J₃₄s₃+h₄^{(ext)}) (80)

Averaging over the configurations of the hidden spin yields an expression that now contains three-body terms as well:

$$( 81 )$$

$$\begin{matrix}{\sum }_{s 4 = \pm 1} {e}^{β {s}_{4} ( {J}_{14} {s}_{1} + {J}_{24} {s}_{2} + {J}_{34} {s}_{3} + {h}_{4} ( ext ) )} = 2 cosh [ β ( {J}_{14} {s}_{1} + {J}_{24} {s}_{2} + \\ {J}_{34} {s}_{3} + {h}_{4}^{( ext )} ) ] \\ = {e}^{ln} \{ 2 cosh [ β ( {J}_{14} {s}_{1} + {J}_{24} {s}_{2} + \\ {J}_{34} {s}_{3} + {h}_{4}^{( ext )} ) ] \}\end{matrix}$$

which can be made explicit by Taylor expanding the exponent above in terms of βJ:

$$( 82 )$$

$$ln ln \{ 2 cosh [ β ( {J}_{14} {s}_{1} + {J}_{24} {s}_{2} + {J}_{34} {s}_{3} + {h}_{4}^{( ext )} ) ] \} = ln ln 2 + \frac{{{β}^{2} ( {J}_{14} {s}_{1} + {J}_{24} {s}_{2} + {J}_{34} {s}_{3} + {h}_{4}^{( ext )} )}^{2}}{2} - \frac{{{β}^{4} ( {J}_{14} {s}_{1} + {J}_{24} {s}_{2} + {J}_{34} {s}_{3} + {h}_{4}^{( ext )} )}^{4}}{12} + … = … - C {β}_{{s}_{1} {s}_{2} {s}_{3}}^{4} + …$$

where C is a constant only depends on Js and h₄^{(ext)}.

A heuristic procedure is used to generate two sets of coupling constants for the energy function (Eq. (80)) such that it recognizes the four correct configurations for the dichotomous case. The partition function was computed for this energy function and fit with the partition function of the following energy function, that contains an explicit three-body term:

$$E ( {s}_{1} , {s}_{2} , {s}_{3} ) = - c - {\sum }_{i} {J}_{i} {s}_{i} - {\sum }_{i < j} {J}_{ij} {s}_{i} {s}_{j} - {J}_{123} {s}_{1} {s}_{2} {s}_{3} \qquad ( 83 )$$

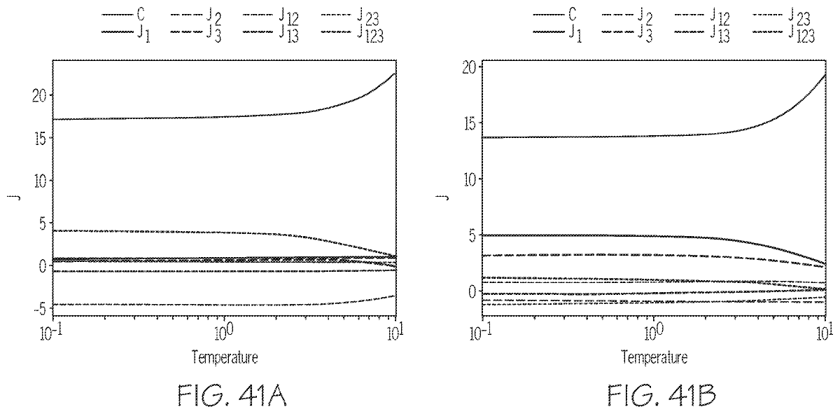

The result of the fit is shown in FIGS. 41A-41B and indicates that, indeed, the ground state energy of the system with the hidden spin is consistent with the presence of a dominant three-body term, consistent with the good performance of the energy function.

FIGS. 41A-41B illustrate the three-body interaction fitting coefficients as a function of temperature in accordance with an embodiment of the present disclosure. FIG. 41A illustrates fitting a well-trained energy function that recognizes all four correct configurations. FIG. 41B illustrates fitting a poorly-trained energy function that recognizes only two correct configurations as such.

Conversely, considering a poorly-trained energy that can only recover two entries from the multiplication table, the tree-body terms is still present, but not dominant.

Next, returning to the general, non-dichotomous setup from Eq. (75), the generative model from FIG. 40B is now used. In one embodiment, only the two-body terms that connect the hidden spin to the visible spins are used. The explicit energy function is shown below:

$$E = - {J}_{3} {s}_{3} - {J}_{4} {s}_{4} - {\sum }_{i = 1}^{3} {J}_{i 4} {s}_{i} {s}_{4} \qquad ( 84 )$$

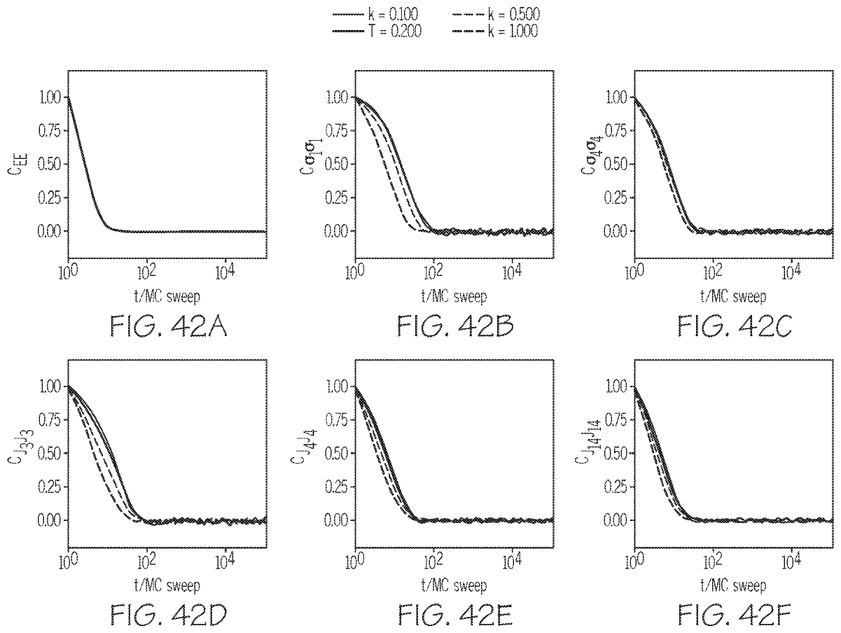

It has been shown that an energy function of all of the rank one interactions on visible spins can recover the training sample distribution. Here, J₁ and J₂, are excluded. Thus, the network has the feed-forward architecture, with an input layer of s₁ and s₂, a hidden layer of spin s₄, and an output layer of only spin s₃. In one embodiment, such a network is trained with equilibrium simulation and retrieved with the feed-forward method. FIGS. 42A-42F illustrate the correlation functions from the Monte Carlo simulation, where the tunneling moves have already been adopted to speed up the training.

FIGS. 42A-42F illustrate the normalized auto-correlation functions of a network of 1 hidden spin in accordance with an embodiment of the present disclosure. During an MC sweep, every hidden spin and visible spin have a chance of 5% for a tunnelling move. In one embodiment, the simulation time is 10⁵ MC sweeps. In one embodiment, the simulation temperature is 1.

Similarly to what was previously discussed, the J and s₄ distributions from the simulation are used for retrieval

$${p}_{rtr} ( {s}_{1} , {s}_{2} , {s}_{3} ) ∝ {\sum }_{{σ}_{1} , {σ}_{2} , {σ}_{3}} {\sum }_{σ 4 = \pm 1} \int {dJe}^{{β}^{′}} ( {J}_{3} {s}_{3} + {J}_{4} {σ}_{4} + \text{?} ) p ( J , {σ}_{1} , … {σ}_{4} ) \qquad ( 85 )$$

$$\text{?} \text{indicates text missing or illegible when filed}$$

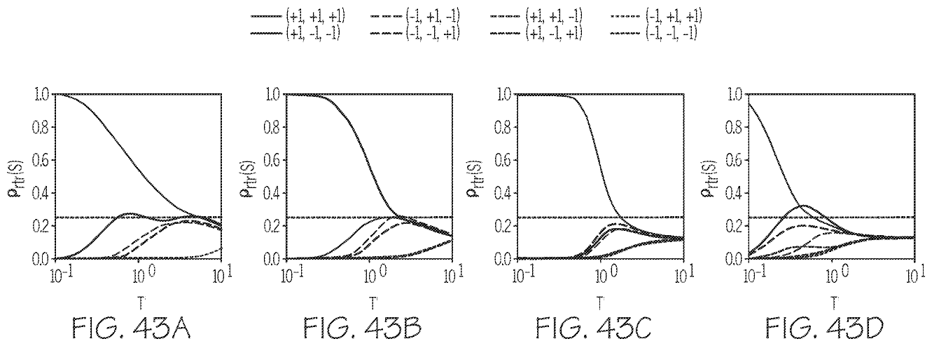

FIGS. 43A-43D demonstrate that good values for the retrieval probability can be achieved at lower k and moderately high retrieval temperatures. In particular, FIGS. 43A-43D illustrate pᵣₜᵣ(s) as a function of T′, following Eq. (85), in accordance with an embodiment of the present disclosure. In connection with FIG. 43A, k=0.1. In connection with FIG. 43B, k=0.2. In connection with FIG. 43C, k=0.5. In connection with FIG. 43D, k=1.0.

As expected, at too high values of the training and retrieval temperature the distinction between the two configurations from Tables 1 and 2 becomes smeared. Numerical issues do occur at lower values k and/or retrieval temperature, which can be partially mitigated by modifying the retrieval protocol according to the following recipe:

$${p}_{rtr} ( {s}_{1} , {s}_{2} , {s}_{3} ) ∝ {\sum }_{{σ}_{1} , {σ}_{2} , {σ}_{3}} {\sum }_{σ 4 = \pm 1} \int dJ \frac{1}{Z ( J , {σ}_{4} )} {e}^{{β}^{′}} ( {J}_{3} {s}_{3} + {J}_{4} {σ}_{4} + \text{?} ) p ( J , {σ}_{1} , … {σ}_{4} ) \qquad ( 86 )$$

$$where$$

$$Z ( J , {σ}_{4} ) = {\sum }_{{s}_{1} , {s}_{2} , {s}_{3}} {e}^{{β}^{′}} ( {J}_{3} {s}_{3} + {J}_{4} {σ}_{4} + {\sum }_{i = 1}^{3} {J}_{i 4} {s}_{i} {σ}_{4} ) \qquad ( 87 )$$

$$\text{?} \text{indicates text missing or illegible when filed}$$

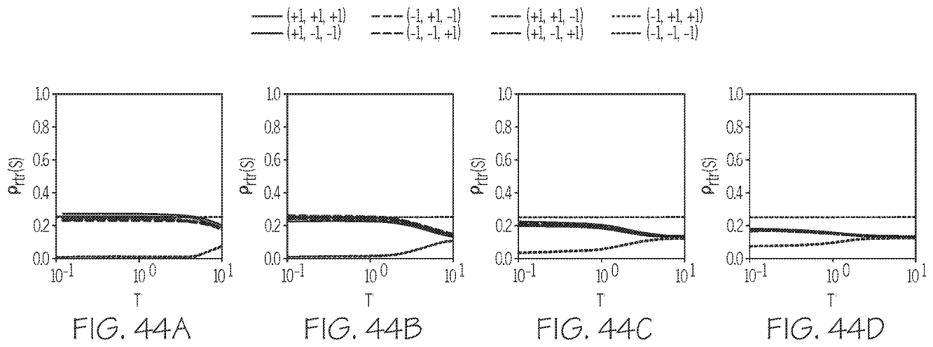

The resulting retrieval probabilities are displayed in FIGS. 44A-44D. In particular, FIGS. 44A-44D illustrate pᵣₜᵣ(s) as a function of T′, following Eq. (86), in accordance with an embodiment of the present disclosure. In connection with FIG. 44A, k=0.1. In connection with FIG. 44B, k=0.2. In connection with FIG. 44C, k=0.5. In connection with FIG. 44D, k=1.0.

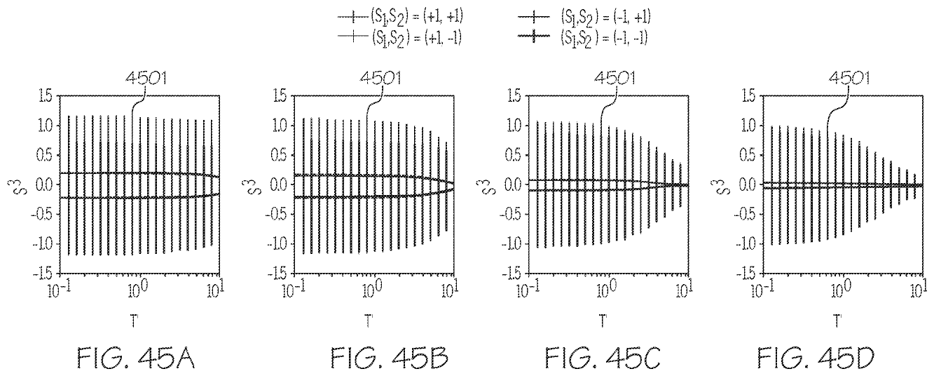

The numerical issues, owing to sampling of large values of the J's have been partially remedied, but could still occur at sufficiently low values of k and/or retrieval temperature. Although the correct sample distribution can be retrieved using the above scheme, the feed-forward method does not work well. As shown in FIGS. 45A-45D, the output fluctuates much so as to scramble the statistics of what was the more likely and less likely configurations in the data. FIGS. 45A-45D illustrate the average output with the feed-forward method in accordance with an embodiment of the present disclosure. Vertical bars 4501 show the RMSD (root mean square deviation). In connection with FIG. 45A, k=0.1. In connection with FIG. 45B, k=0.2. In connection with FIG. 45C, k=0.5. In connection with FIG. 45D, k=1.0.

More hidden spins can be included into the network, using the energy function below:

$$E = - {J}_{3} {s}_{3} - {\sum }_{j > 3} {J}_{j} {s}_{j} - {\sum }_{i = 1}^{3} {\sum }_{j > 3} {J}_{ij} {s}_{i} {s}_{j} \qquad ( 88 )$$

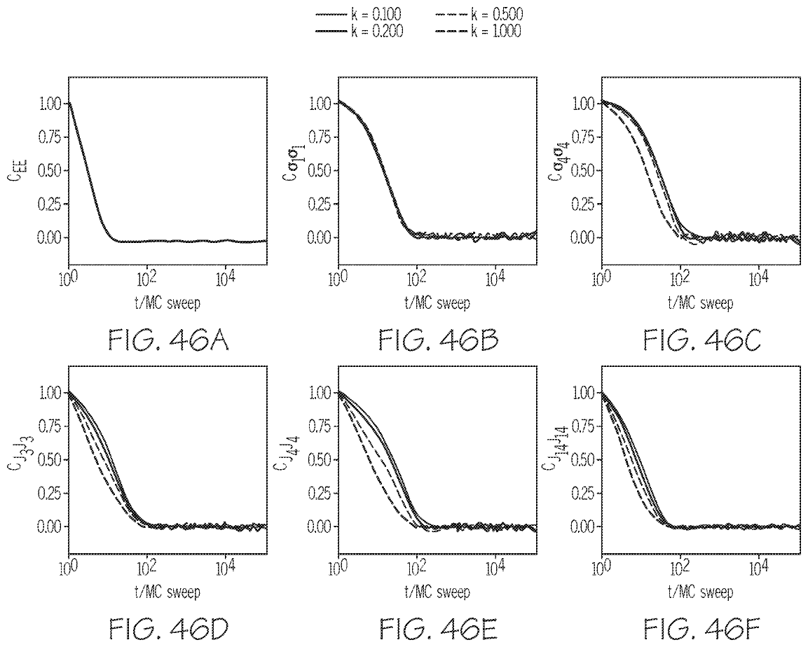

FIGS. 46A-46F show the correlation function for 4 hidden spins. In particular, FIGS. 46A-46F illustrate the normalized auto-correlation functions for the network with 4 hidden spins in accordance with an embodiment of the present disclosure. During a MC sweep, each hidden and visible spin has a 5% chance for the tunnelling move. In one embodiment, the simulation time is 10⁵ MC sweeps. Furthermore, in one embodiment, the simulation temperature is 1.

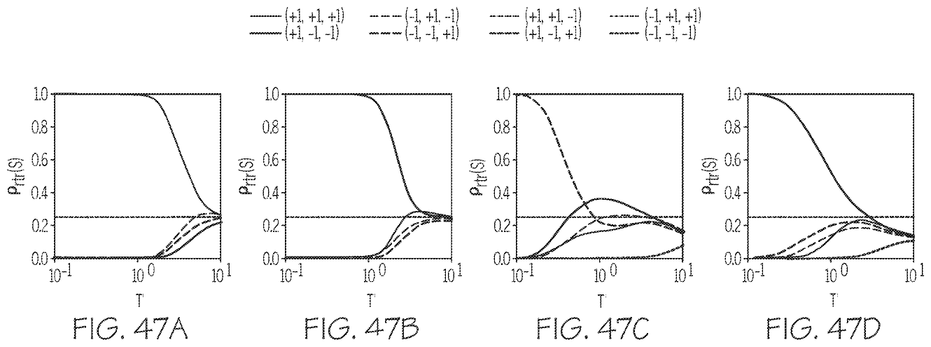

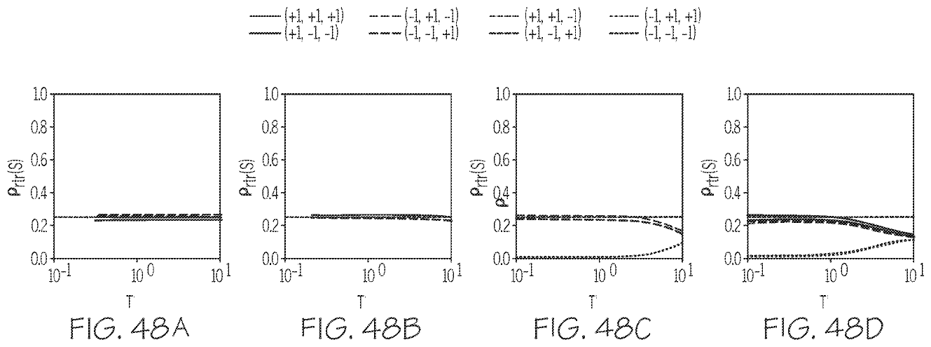

Despite employing tunnelling moves, relaxations are now much longer, compared with FIGS. 42A-42F. The corresponding retrieval probability is shown in FIGS. 47A-47D and FIGS. 48A-48D.

FIGS. 47A-47D illustrate pᵣₜᵣ(s) as a function of T′ where the network has 4 hidden spins in accordance with an embodiment of the present disclosure. In connection with FIG. 47A, k=0.1. In connection with FIG. 47B, k=0.2. In connection with FIG. 47C, k=0.5. In connection with FIG. 47D, k=1.0.

FIGS. 48A-48D illustrate the modified pᵣₜᵣ(s) as a function of T′ where the network has 4 hidden spins in accordance with an embodiment of the present disclosure. In connection with FIG. 48A, k=0.1. In connection with FIG. 48B, k=0.2. In connection with FIG. 48C, k=0.5. In connection with FIG. 48D, k=1.0.

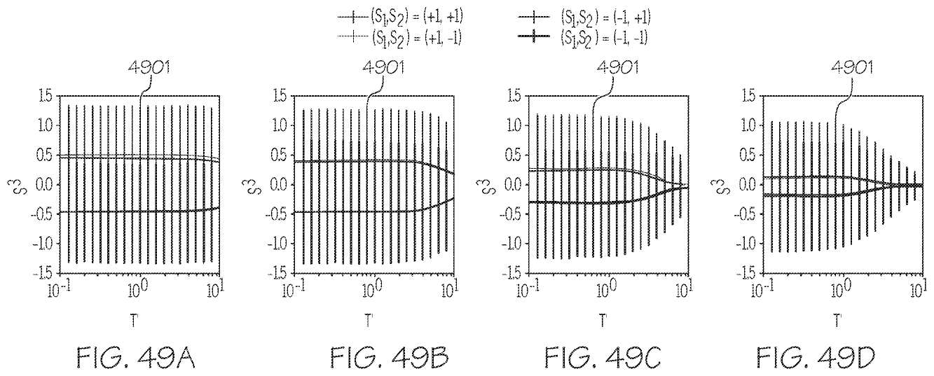

Using a greater number of hidden spins improves performance at higher temperatures but not so for the feed-forward retrieval protocol as shown in FIGS. 49A-49D.

FIGS. 49A-49D illustrate the average output with the feed-forward method in accordance with an embodiment of the present disclosure. In one embodiment, the network has 4 hidden spins. Vertical bars 4901 show the RMSD (root mean square deviation). In connection with FIG. 49A, k=0.1. In connection with FIG. 49B, k=0.2. In connection with FIG. 49C, k=0.5. In connection with FIG. 49D, k=1.0.

Hence, as a result of the foregoing, using hidden spins and interactions of low ranks 1 and 2 can be successfully used to reproduce the statistics of the data. Network geometries have specifically been used to allow one to retrieve the probability of the output spin in a feed-forward fashion. It has been shown, however, that in contrast with retrieval using equilibrium simulation, feed forward retrieval produces a low quality output.

Furthermore, as a result of the forgoing, the principles of the present disclosure disclose a protocol for constructing a free energy surface that encodes arbitrary distribution of data. Such data could correspond to information, sets of patterns or dependencies, and, generally, any knowledge that can be presented in digital form. A given correlation in the data corresponds to a separate, individual minimum on the free energy surface. The latter free energy minimum can be thought of as a “box” storing the information. Specifically, the depth of the box asymptotically gives the log probability of observing the corresponding pattern. And so, for instance, if a particular pixel in a set of images can be either dark or light with probability 60-to-40, the depths of the two corresponding boxes are at −T ln0.6 and −T ln0.4, respectively. Likewise, there will be separate boxes storing the information on the probability of the two pixels having the same or opposite darkness. There are 2^{N} distinct configurations of N binary variables that might have to be book-kept. Thus, the number of minima on the free energy surface, in this worst-case scenario, scales exponentially with the system size and can be thought of as an absence of any pattern. Conversely, the opposite extreme of a finite number of minima can be thought of as corresponding to the presence of a pattern.

Exponentially rapid scaling of the multiplicity of free energy minima with the system size is actually encountered in nature, namely in glassy liquids. There the emergence of such a complex free energy landscape corresponds with a massive breaking of translational symmetry, whereby each molecule becomes transiently trapped in a cage formed by the surrounding molecules. The system becomes locally stable against elastic deformation. The coordinates of individual particles become subject to a bounding potential of mean force. The liquid transport becomes subject to substantial activation barriers and slow down considerably. The lack of a long-range pattern in glassy liquids or glasses is easy to think about: while there is a local rule that (softly) constraints local coordination patterns, correlation between particle locations vanishes already at modest separations of several particle spacings. This complicated situation can be contrasted with the crystal state, which corresponds to essentially a single free energy minimum. The crystal state certainly implies there is a pattern. There is a local rule that allows one to determine the location of every single particle in the system, after one replicated the repeat unit enough times.

In the presently constructed free energy surface, the bounding boxes are formed in the space of auxiliary fields that indicate the sign, and hence the value of each binary variable whose statistics need to be recorded. This can be discussed in physical terms. For example, if a standalone spin σᵢ is subject to a field Jᵢ>0, the equilibrium is shifted towards positive values of the spin. Or, if a spin pair σᵢσⱼ is subject to a field Jᵢⱼ<0, the equilibrium is shifted towards negative values of the product σᵢσⱼ, and so on. At the same time, the object Jᵢⱼ can be thought of as the coupling constant for a two-body spin-spin interaction. Likewise, in one embodiment, higher-order interactions are introduced to encode higher-order correlations. In the worst-case scenario, mentioned above, all possible ways to couple the N spins representing the data are employed, which require 2^{N} coupling constants. It has been shown that although computationally unapproachable, the problem of determining the corresponding many-body coupling constants is well-posed. In view of the computational complexity of the full problem, an alternative problem of finding the best set of coupling constants is posed for a greatly reduced number of spin-spin terms. Since the total number of coupling constants grows combinatorially fast with the interaction order, one's effort is limited to low-order interactions, in practice. Because any energy function that is composed is much smaller than what one would need to encode correlations present in problems of interest, it can be concluded that a large number of such energy functions have to be used at the same time. Encoding arbitrary statistics of a single pixel requires just one such energy function, E=−Jσ, but results in two free energy minima corresponding to the two ways for the spin to polarize. In the case of a strictly dichotomous configuration, where the spin is always up or always down, one free energy minimum suffices.

A vivid analogy can be made between the free energy F({J}) and the problem of non-adiabatic transport of charged particles in condensed media. The auxiliary fields J correspond to the environmental degrees of freedom. Each distinct pattern corresponds to a distinct location of the charged particle. A trained machine can be informally thought of as a pattern of “dips” in the media made by the particle during training. For example, imagine a soft couch that has been set on by a number of people and has stayed deformed after the people got up; the depth of an individual dip reflects the weight of the person analogously to how the depth of the free energy minimum reflects the statistical weight of the respective encoded pattern. Furthermore, owing to the quadratic confining potentials for the auxiliary fields, each of these potentials is entirely analogous to the venerable Marcus parabolas. It has been shown that the Marcus-inverted regime corresponds to an effective scrambling of the patterns corresponding to the two parabolas. In the informal couch analogy above, this corresponds to a situation where two people sat in the same place thus leaving the question of who sat there ambiguous.

The information stored in the so built free energy landscape can be retrieved in a variety of ways. For example, test spins are subjected to the fields whose distribution p(J) was obtained during training. It has been shown that, instead, exclusively the positions of the maxima of the p(J), properly weighted, can be computationally advantageous. In one embodiment, these maxima are determined by vibrational relaxation of the auxiliary variables.

The notion of using multiple energy functions to encode data is useful in the context of predicting the structure and bonding patterns in chemical compounds. The approach of the principles of the present disclosure emphasizes the need for using multiple energy functions and being able to interrogate multiple free energy minima, which requires finite temperatures. These notions are consonant with the principles behind the Helmholtz machine, yet the present results indicate that a single Helmholtz machine cannot encode realistic data. In fact, each free energy minimum should be thought of as a separate Helmholtz machine.

In one embodiment, the principles of the present disclosure focus on finding sets of the coupling constants that gives rise to p(J) distributions that have the smallest number of peaks. If such a set of constants is found for a specific problem of interest, the pattern may be said to have been recovered. Such a situation is exemplified using a simple, completely surveyable problem of the group multiplication table of rank two, which is complementary to the Boolean XOR problem. One needs only three spins to represent the information. Here, the presence of the pattern corresponds with the fact that the underlying energy function consists exclusively of the three-body term, while the free energy function generally has two minima. In the absence of such knowledge, in one embodiment, at least three energy terms are used. The resulting number of free energy minima is now eight, a considerable increase relatively to the situation when the pattern is known. Eight is the largest possible number of free energy minima necessary to encode an arbitrary distribution for three binary degrees of freedom.

Furthermore, the combinatorially large size of the space of coupling constants is addressed. In one embodiment, couplings exclusively of order one and two are used, while adding additional anharmonic degrees of freedom in the form of hidden spins, and, specifically, so that the resulting network can be interrogated in a feed-forward fashion. It has been shown that such networks can reproduce data distributions well when interrogated using equilibrium simulation but not using feed-forward propagation.

Additionally, the finite-temperature approach of the present disclosure is conducive for finding optimal sets of underlying energy functions that are computationally affordable. Indeed, the auxiliary fields J are regarded as a pre-specified set of particles. But the number and precise identity of these particles does not have to be specified at the onset. Instead, one might allow the particle to appear or disappear subject to a pertinent chemical potential. Likewise, one can add or remove hidden spins. From the viewpoint of a neural network, this would correspond to the creation of new neurons in the presence of a stimulus, such as information influx, or, purely statistically, under evolutionary pressure, etc.

As a result of the foregoing, the principles of the present disclosure improve the accuracy in AI models recognizing patterns in the data and drawing conclusions in a manner that emulates human expertise by constructing a free energy surface that encodes an arbitrary distribution of data.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

In one embodiment of the present disclosure, a computer-implemented method for artificial intelligence modeling comprises receiving an arbitrary distribution of data. The method further comprises constructing, in a memory, a free energy surface that encodes the arbitrary distribution of data, where correlations in the encoded data correspond to separate individual minima on the free energy surface.

Additionally, in one embodiment of the present disclosure, the separate individual minima comprise bounding boxes that store at least some information from the arbitrary distribution of data such that at least one dimension of each of the bounding boxes provides a probability of observing a given pattern.

Furthermore, in one embodiment of the present disclosure, the method additionally comprises forming, in the free energy surface, the bounding boxes in a space of auxiliary fields that indicate values of binary variables whose statistics are to be recorded.

Additionally, in one embodiment of the present disclosure, the auxiliary fields indicate signs of the binary variables.

Furthermore, in one embodiment of the present disclosure, the method additionally comprises using quadratic confining potentials for the auxiliary fields.

Additionally, in one embodiment of the present disclosure, the method further comprises using multiple energy functions to encode the arbitrary distribution of data.

Furthermore, in one embodiment of the present disclosure, the method additionally comprises retrieving information from the free energy surface via interrogation of a plurality of the multiple energy functions.

Other forms of the embodiments of the method described above are in a system and in a computer program product.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for improving the accuracy in artificial intelligence modeling in recognizing patterns and drawings conclusions in a manner that emulates human expertise, the method comprising:
receiving an arbitrary distribution of data; and
constructing, in a memory, a free energy surface that encodes said arbitrary distribution of data, wherein correlations in said encoded data correspond to separate individual minima on said free energy surface.

2. The method as recited in claim 1, wherein said separate individual minima comprise bounding boxes that store at least some information from said arbitrary distribution of data such that at least one dimension of each of said bounding boxes provides a probability of observing a given pattern.

3. The method as recited in claim 2, wherein said constructing comprises:
forming, in said free energy surface, said bounding boxes in a space of auxiliary fields that indicate values of binary variables whose statistics are to be recorded.

4. The method as recited in claim 3, wherein said auxiliary fields indicate signs of said binary variables.

5. The method as recited in claim 3, wherein said forming comprises:
using quadratic confining potentials for said auxiliary fields.

6. The method as recited in claim 1 further comprising:
using multiple energy functions to encode said arbitrary distribution of data.

7. The method as recited in claim 6 further comprising:
retrieving information from said free energy surface.

8. The method as recited in claim 7, wherein said information is retrieved from said free energy surface via interrogation of a plurality of said multiple energy functions.

9. The method as recited in claim 1, wherein said arbitrary distribution of data comprises binary data.

10. The method as recited in claim 1, wherein said free energy surface is used as a mold for a test function of a user's choice.

11. The method as recited in claim 1, wherein a number of minima on said free energy surface is 2^{N}, wherein said N is a number of bits representing a problem in question.

12. The method as recited in claim 11, wherein said number of bits represents pixels for a set of images.

13. The method as recited in claim 1 further comprising:
using hidden spins to emulate higher-order interactions between visible spins that directly represent said data.

14. A computer program product for improving the accuracy in artificial intelligence modeling in recognizing patterns and drawings conclusions in a manner that emulates human expertise, the computer program product comprising one or more computer readable storage mediums having program code embodied therewith, the program code comprising programming instructions for:
receiving an arbitrary distribution of data; and
constructing, in a memory, a free energy surface that encodes said arbitrary distribution of data, wherein correlations in said encoded data correspond to separate individual minima on said free energy surface.

15. A system, comprising:
a memory for storing a computer program for improving the accuracy in artificial intelligence modeling in recognizing patterns and drawings conclusions in a manner that emulates human expertise; and
a processor connected to the memory, wherein the processor is configured to execute program instructions for:
receiving an arbitrary distribution of data; and
constructing, in a memory, a free energy surface that encodes said arbitrary distribution of data, wherein correlations in said encoded data correspond to separate individual minima on said free energy surface.
